(19) United States
(12) Patent Application Publication
(10) Pub. No.: US 2005/0106068 A1
(43) Pub. Date: May 19, 2005

(54) Sol-gel dendron separation and extraction capillary column

(76) Inventors: Abdul Malik, Tampa, FL (US); Abuzar Kabir, Tampa, FL (US); George R. Newkome, Akron, OH (US); Kyung Soo Yoo, Akron, OH (US)

Correspondence Address: SMITH & HOPEN PA, 15950 BAY VISTA DRIVE, SUITE 220, CLEARWATER, FL, 33760, US

(21) Appl. No.: 10/716,310

(22) Filed: Nov. 18, 2003

(51) Int. Cl. G01N 30/02

(52) U.S. Cl. 422/89; 422/101

(57) ABSTRACT

The present invention provides for a capillary column including a tube structure having an inner surface and a sol-gel substrate bonded to a dendrimer substrate to form a sol-gel dendrimer matrix that bonds to a portion of the inner surface of the tube structure to form a surface-bonded stationary phase coating thereon. The present invention additionally provides for a capillary column including a tube structure having an inner surface, a stationary phase coating attached to a portion of the inner surface, and a dendrimer moiety bonded to the stationary phase coating. Further, a sol-gel dendrimer coated apparatus including a structure having a surface and a sol-gel substrate bonded to a dendrimer substrate to form a sol-gel dendrimer matrix coating the surface thereon is provided. The present invention also provides for a one-step method for making and preparing a column and a method of making the sol-gel and dendrimer solution.

### CROSS REFERENCE TO RELATED DISCLOSURES

The present application is a U.S. National Stage application claiming the benefit of prior filed International Application, Serial Number PCT/US02/15818, filed May 16, 2002 which International Application claims a priority date of May 18, 2001 based on prior filed U.S. provisional application Ser. No. 60/292,162.

### FIELD OF THE INVENTION

The present invention relates to analytical separation and extraction technology. More specifically, the present invention relates to separation and extraction columns for use in separating and/or extracting components.

### BACKGROUND OF THE INVENTION

The introduction of an open tubular column by Golay (Golay, M. J. E., et al.,) about four decades ago, has revolutionized the analytical capability of gas chromatography (hereinafter “GC”). More specifically, capillary GC has matured into a separation technique that is widely used in various fields of science and industry (Altgelt, K. H., et al.; Clement, R. E.; Berezkin, V. G., et al.; and Tebbett, I.). Capillary GC is a separation technique in which the vapor phase of a sample in a gaseous, mobile phase passes through a capillary tube whose inner walls contain a thin film of an adsorbing or absorbing medium (i.e., stationary phase). Because of differential interactions of the sample components with the stationary phase, the individual components of the sample move through the column with different velocities. This leads to the physical separation of the sample components into individual chromatographic zones as they move down the column with their characteristic velocities. The separated components are detected instrumentally as they are eluted from the column.

Contemporary technology for the preparation of open tubular columns is time-consuming. It consists of three major, individually executed steps (Poole, C. F., et al.): capillary surface deactivation (Woolley, C. L. et al.), static coating (Bouche, J. et al.), and stationary phase immobilization (Blomberg L. G.). Involvement of multiple steps in conventional column technology increases the fabrication time and is likely to result in greater column-to-column variation. The column deactivation step is critically important for the GC separation of polar compounds that are prone to undergo adsorptive interactions (e.g., with the silanol groups on fused silica capillary inner walls). In conventional column technology, deactivation is usually carried out as a separate step and involves chemical derivatization of the surface silanol groups. Various reagents have been used to chemically deactivate the surface silanol groups (de Nijs; R. C. M., et al.; Schomburg, G. et al.; Blomberg, L. et al.; and Lee, M. L. et al.). Effectiveness of these deactivation procedures greatly depends on the chemical structure and composition of the fused silica surface to which they are applied.

Of special importance are the concentration and mode of distribution of surface silanol groups. Because the fused silica capillary drawing process involves the use of high temperatures (˜2,000° C.), the silanol group concentration on the drawn capillary surface can initially be low due to the formation of siloxane bridges under high-temperature drawing conditions. During subsequent storage and handling, some of these siloxane bridges can undergo hydrolysis due to reaction with environmental moisture. Thus, depending on the post-drawing history, even the same batch of fused silica capillary can have different concentrations of the silanol groups that can also vary by the modes of their distribution on the surface.

Moreover, different degrees of reaction and adsorption activities are shown by different types of surface silanol groups (Lawrocki, J.). As a result, fused silica capillaries from different batches or even from the same batch, but stored and/or handled under different conditions, often cannot produce identical surface characteristics after being subjected to the same deactivation treatments. This makes surface deactivation a difficult procedure to reproduce. To overcome these difficulties, some researchers have used hydrothermal surface treatments to standardize silanol group concentrations and their distributions over the surface (Sumpter, S. R. et al.). This additional step, however, makes the time consuming column making procedure even longer. Static coating is another time-consuming step in conventional column technology. A typical 30-m long column can require as much as ten hours or more for static coating. The duration of this step can vary depending on the length and diameter of the capillary, and the volatility of the solvent used.

To coat a column by the static coating technique, the fused silica capillary is filled with a stationary phase solution prepared in a low-boiling solvent. One end of the capillary is sealed using a high viscosity grease or by some other means (Abe, I. et al.) and the other end is connected to a vacuum pump. Under these conditions, the solvent begins to evaporate from the capillary end connected to the vacuum pump, leaving behind the stationary phase that becomes deposited on the capillary inner walls as a thin film. Stationary phase film of desired thickness could be obtained by using a coating solution of appropriate concentration that can be easily calculated through simple equations (Ettre, L. S. et al.).

In static coating, two major drawbacks are encountered. First, the technique is excessively time consuming, and not very suitable. for automation. Second, the physically coated stationary phase film shows a pronounced tendency to rearrangements that can ultimately result in droplet formation due to Rayleigh instability (Bartle, K. D. et al.). Such a structural change in the coated films can serve as a cause for the deterioration or even complete loss of the column's separation capability.

To avoid these undesirable effects, static-coated stationary phase films need to be stabilized immediately after their coating. This is usually achieved by stationary phase immobilization through free radical cross-linking (Wright, B. W. et al.) that leads to the formation of chemical bridges between coated polymeric molecules of the stationary phase. In such an approach, stability of the coated film is achieved not through chemical bonding of the stationary phase molecules to the capillary walls, but mainly through an increase of their molecular size and consequently, through decrease of their solubility and vapor pressure.

Such an immobilization process has a number of drawbacks. First, polar stationary phases are difficult to immobilize by this technique (Yakabe, Y., et al.). Second, free radical cross-linking reactions are difficult to control to ensure the same degree of cross-linking in different columns with the same stationary phase. Third, cross-linking reactions can lead to significant changes in the polymer structure and chromatographic properties of the resulting immobilized polymer can significantly differ from those of the originally taken stationary phase (Blomberg L. G.). All these drawbacks add up to make column preparation by conventional techniques a task that is difficult to control and reproduce (Blomberg, L., et al.).

In order to overcome all of the above problems, a preparation of a GC capillary column including a tube structure and a deactivated surface-bonded sol-gel coating on a portion of the tube structure forming a stationary phase was disclosed and claimed in PCT Application PCT/US99/19113, published as WO 00/11463, to Malik et al. The invention disclosed therein is for a structure for forming a capillary tube, e.g., for gas chromatography, and a technique for forming such capillary tube. The capillary tube includes a tube structure and a deactivated surface-bonded sol-gel coating on a portion of the tube structure to form a stationary phase coating on that portion of the tube structure. The deactivated sol-gel stationary phase coating enables separation of analytes while minimizing adsorption of analytes on the separation column structure. This type of column was a significant advancement in the art, but it was recognized that certain improvements would greatly enhance the performance of the sol-gel coated column.

As is the case with most separation and/or extraction columns, increased sensitivity is always a desired improvement. Thus, in addition to the use of sol-gel coatings with conventional stationary phases (e.g., sol-gel polydimethylsiloxane or sol-gel polyethylene glycol), the use of an additional selective organic ligands such as a dendrimer is desirable. Since the start of dendrimer chemistry, preparation of functional dendrimers has progressed and found use in a number of applications such as host-guest chemistry, carbohydrate chemistry (N. Jayaraman et al. and R. Roy et al.) (i.e., the so-called “sugar ball”)(K. Aoi et al., 1995, K. Aoi, 1996, K. Aoi et al., 1997, K. Aoi et al., 1998), metallodendrimers (Newkome et al., 1999, D. Astruc, et al., C. M. Cadado et al., I. Cuadrado et al., 1996, I, Cuadrado et al., 1999, C. Gorman, S. Serroni et al., F. J. Stoddart et al., M. Venturi et al.), catalysis (M. T. Reetz, P. Bhyrappa et al., S. Bhattacharya et al., C. Köllner et al., 1998, C. Köllner et al., 1999), and surface chemistry (A. Hierlemann et al.). These various applications were made possible either due to their internal or external modifications, which have a general spherical shape, a surface capable of intermolecular interactions with its immediate environment, and an inner regime capable of utilitarian supramolecular characteristics (See also, U.S. Pat. No. 5,136,096 to Newkome et al, U.S. Pat. No. 5,650,101 to Newkome et al., U.S. Pat. No. 5,703,271 to Newkome et al., and U.S. Pat. No. 5,773,551 to Newkome et al.)

Various polysiloxane-based materials that are most commonly used as stationary phases in GC are prepared by chemically binding functional pendant groups to a polysiloxane backbone. Among the used pendant groups are methyl (C. R. Trash), phenyl (A. T. James), biphenyl (M. L. Lee et al.), cyanopropyl (K. E. Markides et al.), cyanobiphenyl (A. Malik et al., 1992), liquid crystalline moieties (J. S. Bradshaw et al.), chiral moieties (H. Frank et al., Koppenhoefer et al.), and molecular cavities including cyclodextrins (G. Yi et al., 1993), crown ether (D. D. Fine et al.), calixarenes (X. H. Lai et al. and J. H. Park et al.), and cyclophanes (T. Shinbo et al.). Among non-silicone stationary phases are polyethylene glycols (S. B. Bendre, et al. and P. Sandra et al.), and molten salts of various organic acids (C. F. Poole et al.).

As previously described, open tubular gas chromatography, which is the predominant format in current gas chromatography practice, a uniform, thin coating of the stationary phase is created on the inner surface of a fused silica capillary. In the conventional approach, this is achieved by employing three major steps (B. J. Tarbet et al.): surface deactivation (C. L. Woolley et al.), static coating (J. Bouche et al.), and immobilization of the coated film (L. G. Blomberg). Since these individually executed steps often involve time-consuming procedures, the overall column fabrication process is often very lengthy and labor-intensive, which is directly reflected in their price. To overcome these drawbacks of conventional column technology, in recent years a sol-gel chemistry-based approach has been developed (L. G. Blomberg) that drastically reduces the column fabrication time by elegantly combining all three major manufacturing steps into a simple one-step procedure. Moreover, in the sol-gel approach the stationary phase film is chemically bonded to the inner surface of the capillary. Because of this chemical bonding, sol-gel coatings are characterized by significantly higher thermal and solvent stability (D. Wang et al., J. D. Hayes et al., 1997, and S. L. Chong et al.). In addition, the sol-gel approach to column technology being quite general, it is applicable to a wide range of techniques (J. D. Hayes et al., 1997, S. L. Chong et al., J. D. Hayes et al., 2001, and J. D. Hayes et al., 2000), and allows for the column preparation both in open tubular (D. Wang et al., J. D. Hayes et al., 1997, and J. D. Hayes et al., 2001), and monolithic formats (J. D. Hayes et al., 2000).

Because of their tree-like branched architecture, the attachment of functionalized dendrons is a potential candidate for novel stationary phases in analytical separations. This opens new possibilities in achieving new heights of selectivity and performance in analytical separations through the use of dendritic monomers in novel stationary phases. Incorporating desired terminal groups could create a variety of useful stationary phases.

Accordingly, it would be useful to develop methods and columns that have greater performance and selectivity. Specifically, it would be useful to utilize the ability of dendritic substances to separate various substances. Thus, the synthesis, extended silane functionalization, and facile attachment of highly branched building blocks containing benzyl ether terminal groups would be very beneficial. Also, a sol-gel chemistry-based approach to in situ creation of dendrimerized stationary phase coatings on the inner walls of fused silica capillary columns for gas chromatography would be valuable.

### SUMMARY OF THE INVENTION

According to the present invention, there is provided a capillary column including a tube structure having an inner surface and a sol-gel substrate bonded to a dendrimer substrate to form a sol-gel dendrimer coating, wherein the sol-gel dendrimer coating bonds to a portion of the inner surface of the tube structure to form a surface-bonded stationary phase coating thereon. The present invention further provides for a gas chromatography column including the capillary column and the sol-gel dendrimer matrix. The present invention additionally provides for a capillary column including a tube structure having an inner surface, a stationary phase coating attached to at least a portion of the inner surface, and a dendrimer moiety chemically bonded to the stationary phase coating for selective interactions with various analytes. Further, a sol-gel dendrimer coated apparatus including a structure having a surface and a sol-gel substrate bonded to a dendrimer substrate to form a sol-gel dendrimer matrix, wherein the sol-gel dendrimer matrix bonds to a portion of the surface of the structure to form a surface-bonded stationary phase coating thereon is provided. The present invention also provides for a one-step method for preparing the capillary column described herein. Additionally, the present invention provides for a method of making a sol-gel and dendrimer solution and placement into the capillary column described herein.

### DESCRIPTION OF THE DRAWINGS

Other advantages of the present invention will be readily appreciated as the same becomes better understood by reference to the following detailed description in connection with the accompanying drawings wherein:

FIG. 1 is a longitudinal, cross-sectional view of an embodiment of a capillary column of the present invention;

FIG. 2 is a schematic representation (Scheme 1) of the formation of a selected dendritic reagent or isocyanate monomer utilized in an embodiment of the present invention, wherein the isocyanate monomer (Structure 2) is formed by simple reduction of the alkyl nitro group to a corresponding amine that, with triphosgene, yields the desired isocyanate monomer (Structure 2);

FIG. 3 is a schematic representation (Scheme 2) of the formation of a selected dendritic reagent or isocyanate monomer utilized in an embodiment of the present invention, wherein the isocyanate monomer formed is an isocyanate-9 benzyl ether (Structure 7);

FIG. 4 is a schematic representation (Scheme 3) of the formation of a desired dendritic reagent or isocyanate monomer (Structure 12) utilized in an embodiment of the present invention, wherein the isocyanate monomer is an isocyanate-27 benzyl ether (Structure 12);

FIGS. 5A, 5B, and 5C are schematic representations (Scheme 4) of the synthesis of the dendritic silane reagents (Structure 3, Structure 8, and Structure 13) from selected dendritic reagents or isocyanate monomers (Structure 2, Structure 7, and Structure 12, respectively), wherein the synthesis occurs by treatment of isocyanate monomers possessing a focal isocyanate moiety and terminal benzyloxy groups with 3-triethoxysilylpropylamine;

FIG. 6 is a schematic representation (Scheme 5) of a hydrolysis reaction of methyltrimethoxysilane to form a hydrolyzed methyltrimethoxysilane (FIG. 6a) and benzyl-terminated polymer to form a hydrolyzed benzyl-terminated dendron (FIG. 6b);

FIG. 7A is a schematic representation (Scheme 6A) of a polycondensation reaction of the hydrolyzed methyltrimethoxysilane, while FIG. 7B is a schematic representation (Scheme 6B) of a polycondensation reaction of the hydrolyzed benzyl-terminated dendron;

FIG. 8 is a schematic representation (Scheme 7) of a reaction of the polycondensation product with a capillary glass inner surface 14;

FIG. 9 is a schematic representation (Scheme 8) of a deactivation of residual silanol groups, attached to a glass surface, utilizing 1,1,1,3,3,3-hexamethyldisilazane;

FIG. 10 presents chromatograms illustrating the GC separation of Grob test mixture (Newkome et al., 2001) on sol-gel dendrimer stationary phases with first- (FIG. 10A), second- (FIG. 10B), and third- (FIG. 10C) generation benzyl-terminated dendritic material with conditions of: 10 m×0.25 mm i.d. fused silica capillary column; temperature programming from 40° C. @ 6° C./minutes; helium as the carrier gas, 40 cm/s; split injection (100:1), 300° C.; flame ionization detector, 350° C., and peaks: (1) n-decane, (2) 2,3-butanediol, (3) n-undecane, (4) 1-nonanal, (5) 1-octanol, (6) 1,6-dimethylaniline, (7) 2,6-dimethylphenol, (8) methyldecanoate, (9) dicyclohexylamine, (10) methylundecanoate, (11) methyldodecanoate;

FIG. 11 illustrates a GC separation of a mixture of aldehydes on a phenyl-terminated sol-gel dendrimer stationary phase with conditions of: 10 m×0.25 mm i.d. fused silica capillary column; temperature programming from 60° C. @ 6° C./minutes; helium as the carrier gas; split injection (100:1), 300° C.; flame ionization detector, 350° C., and peaks: (1) benzaldehyde, (2) p-tolualdehyde, 3) nonylaldehyde, (4) n-decylaldehyde, (5) dodecylaldehyde;

FIG. 12 illustrates a GC separation of a mixture of ketones on a capillary column with phenyl-terminated sol-gel dendrimer stationary phase with conditions of: 10 m×0.25 mm i.d. fused silica capillary column; temperature programming from 60° C. @ 6° C./minutes; helium as the carrier gas, 40 cm/s; split injection (100:1), 300° C.; flame ionization detector, 350° C., and peaks: (1) cyclohexanone, (2) 5-nonanone, (3) butyrophenone, (4) valerophenone, (5) heptanophenone;

FIG. 13 illustrates a capillary GC separation of a mixture of aromatic amines on a phenyl-terminated sol-gel dendrimer stationary phase with conditions of: 10 m×0.25 mm i.d. fused silica capillary column; temperature programming from 60° C. @ 6° C./minutes; helium as the carrier gas, 40 cm/s; split injection (100:1), 300° C., flame ionization detector, 350° C., and peaks: (1) pyridine, (2) N-methylaniline, (3) 2-ethylaniline, (4) 4-ethylaniline, (5) N-butylaniline;

FIG. 14 illustrates a chromatogram of capillary GC separation of a mixture of alkanes on a phenyl-terminated sol-gel dendrimer stationary phase, wherein the conditions are: 10 m×0.25 minutes i.d. fused silica capillary column; temperature programming from 80° C. to 250° C. at 10° C./minutes; helium as the carrier gas; split/splitness injection, 300° C.; flame ionization detector, 350° C. (Peaks: n-dodecane, (6) n-tridecane, (7) n-tetradecane, (8) n-pentadecane);

FIG. 15 illustrates a GC separation of a mixture of polycyclic aromatic hydrocarbons on a capillary column with phenyl-terminated sol-gel dendrimer stationary phase with conditions of: 10 m×0.25 mm i.d. fused silica capillary column; temperature programming from 80° C. (0.5 minute hold) to 250° C. at 10° C./minutes; helium as the carrier gas; split/splitless injection, 300° C.; flame ionization detector, 350° C., and peaks: (1) naphthalene, (2) acenaphthene, (3) fluorene, (4) anthracene;

FIG. 16 is a chromatogram illustrating the microextraction of PAHs utilizing an embodiment of a sol-gel dendrimer coating on a capillary column of the present invention, wherein the extraction conditions are: sol-gel dendrimer-coated extraction capillary of 13 cm×250 μm i.d., extraction from water for 30 minutes, the GC conditions are: sol-gel PDMS coated column of 10 m×250 μm i.d. at 30° C. for 5 minutes @ 15° C./minute, splitless injection, 300° C., FID; 350° C., with peaks at: (1) acenapthene, (2) fluorene, (3) phenanthrene, (4) fluoranthrene, (5) pyrene;

FIG. 17 is a chromatogram illustrating the microextraction of aldehydes utilizing an embodiment of the sol-gel dendrimer coated capillary column of the present invention, wherein the extraction conditions. are: sol-gel dendrimer coated extraction capillary of 13 cm×0.25 mm i.d., extraction from water for 30 minutes, the GC conditions are: sol-gel PDMS coated column of 10 m×0.25 mm i.d. at 30° C. for 5 minutes @ 15° C./minute, splitless injection, 300° C., FID; 350° C., with Peaks: (1) nonylaldehyde, (2) m-tolualdehyde, (3) N-decyl aldehyde, (4) undecylic aldehyde;

FIG. 18 is a chromatogram illustrating the microextraction of ketones utilizing an embodiment of the sol-gel dendrimer coated capillary column of the present invention, wherein the extraction conditions are: sol-gel dendrimer coated extraction capillary of 13 cm×0.25 mm i.d., extraction from water for 30 minutes, the GC conditions are: sol-gel PDMS coated column of 10 m×0.25 mm i.d. at 30° C. for 5 minutes @ 15° C./minute, splitless injection, 300° C., FID; 350° C., with peaks: (1) butyrophenone, 200 ppb, (2) valerophenone, 100 ppb, (3) hexanophenone, 50 ppb, (4) heptanophenone, 25 ppb, (5) benzophenone, 100 ppb;

FIG. 19 is a chromatogram illustrating the microextraction of alcohols utilizing an embodiment of the sol-gel dendrimer coated capillary column of the present invention wherein the extraction conditions are: sol-gel dendrimer coated extraction capillary of 13 cm×0.25 mm i.d., extraction from water for 30 minutes, the GC conditions are: sol-gel PEG coated column of 10 m×0.25 mm i.d. at 30° C. for 5 minutes @ 15° C./minute, splitless injection, 300° C., FID; 350° C., with peaks: (1) 1-octanol (500 ppb), (2) decanol (100 ppb), (3) lauryl alcohol (40 ppb), (4) myristyl alcohol (100 ppb);

FIG. 20 is a chromatogram illustrating the microextraction of phenols utilizing an embodiment of the sol-gel dendrimer coated capillary column of the present invention wherein the extraction conditions are: sol-gel dendrimer coated extraction capillary of 13 cm×0.25 mm i.d., extraction from water for 30 minutes, the GC conditions are: sol-gel PEG coated column of 10 m×0.25 mm i.d. at 30° C. for 5 minutes @ 15° C./minute, splitless injection, 300° C., FID; 350° C., with peaks at: (1) 2-chlorophenols, (2) 2,5-dimethyiphenol, (3) 3,4-dichlorophenol, (4) 2,4,6-trichlorophenol, (5) 4-chloro-3-methylphenol;

FIG. 21 is a chromatogram illustrating the microextraction of 2,6-Di-tert-butyl-p-cresol (BHT) utilizing an embodiment of the sol-gel dendrimer coated capillary column of the present invention, wherein the extraction conditions are: sol-gel dendrimer coated extraction capillary of 13 cm×0.25 mm i.d., extraction from water for 30 minutes, the GC conditions are: sol-gel PDMS coated column of 10 m×0.25 mm i.d. at 30° C. for 5 minutes @ 15° C./minute, splitless injection, 300° C., FID; 350° C.;

FIG. 22 is a graph illustrating the extraction kinetics of fluorene on an embodiment of a sol-gel dendrimer coated capillary column of the present invention; and

FIG. 23 is a graph illustrating the extraction kinetics of 2,4,6-trichlorophenol on an embodiment of a sol-gel dendrimer coated capillary of the present invention.

### DETAILED DESCRIPTION OF THE INVENTION

Generally, the present invention provides for a sol-gel dendrimer coated apparatus including a structure having a surface and a sol-gel substrate bonded to a dendrimer substrate to form a sol-gel dendrimer matrix. The sol-gel dendrimer matrix bonds to a portion of the surface of the structure to form a surface-bonded stationary phase coating thereon.

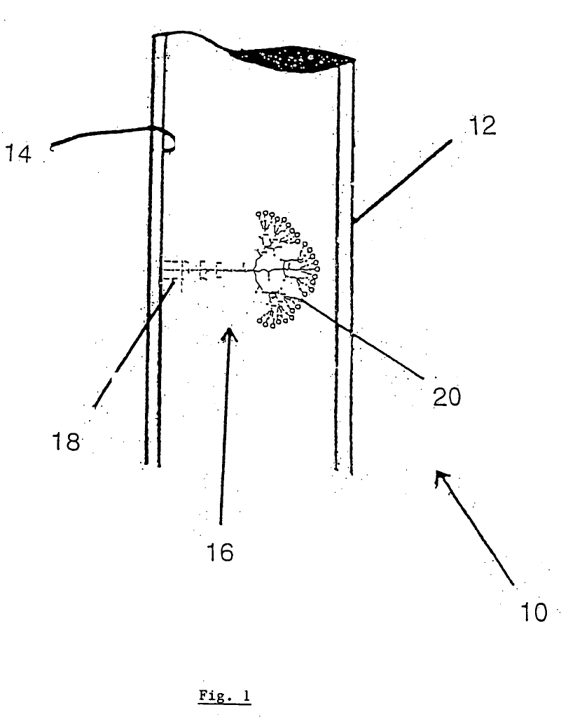

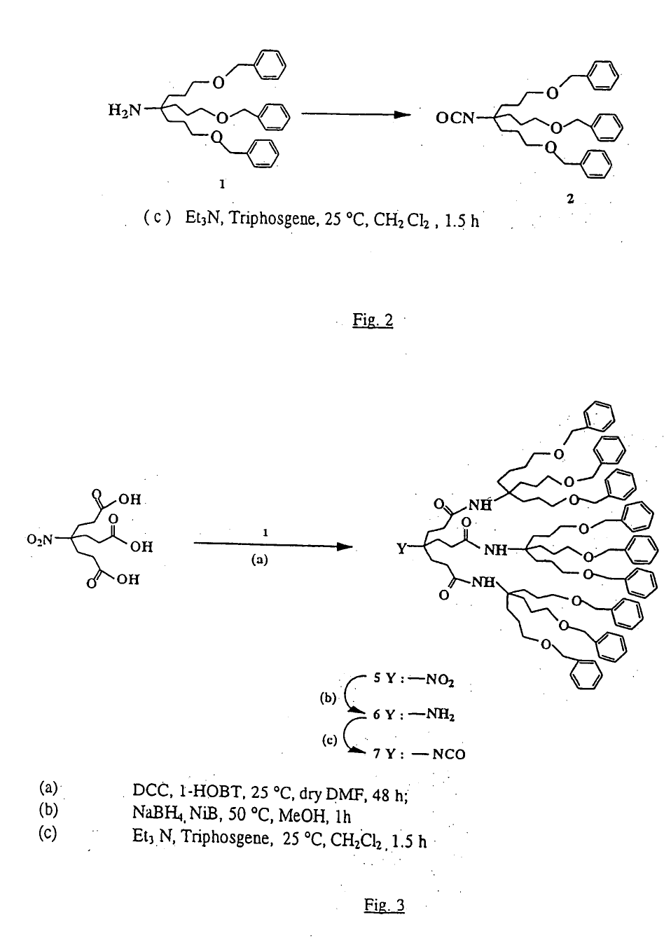

In one embodiment, a sol-gel dendron separation and extraction capillary column constructed in accordance with the present invention is indicated at 10 in FIG. 1. The capillary column 10 separates and/or extracts analytes, substances, or other components from a solution. The capillary column 10 includes a tube structure 12 having an inner surface 14 and a sol-gel dendrimer stationary phase coating 16 or sol-gel dendrimer matrix 16 attached to at least a portion of the inner surface 14 to coat the inner surface 14 thereon. The sol-gel dendrimer stationary phase coating 16 or sol-gel dendrimer matrix 16 includes a sol-gel substrate 18 bonded to a dendrimer mechanism 20 or substrate 20. The sol-gel substrate 18 chemically bonds and attaches to the inner surface 14 of the tube structure 12. The dendrimer mechanism 20 or substrate 20 selectively binds to a selected ligand, component, analyte, or other substance known to those of skill of the art.

The present invention provides for the synthesis, extended silane functionalization, and facile attachment procedures for highly branched isocyanate monomers. Preferably, the isocyanates have terminal benzyl ether groups, but any similar isocyanate monomer can be used with the present invention. More specifically, the present invention provides for the in situ creation of sol-gel dendrimer stationary phase coatings for high-resolution capillary gas chromatography. The present invention also provides for a simple, one-step procedure that leads to the creation of a surface-bonded sol-gel dendritic stationary phase on an inner surface of a fused silica capillary. Such a stationary phase provides for unique selectivity in gas chromatography (hereinafter, “GC”), which results from the highly branched structures of the isocyanate monomers. A marked difference is observed in the chromatographic selectivity of these sol-gel stationary phases containing different generation dendrons. As a result, the present invention provides for achievement of enhanced performance and selectivity in chromatographic separations through the use of sol-gel dendritic stationary phases.

The key aspect of the present invention is the use of sol-gel substrates in conjunction with functionalized dendrimers having a tree-like branched architecture. The use of both the sol-gel substrate along with the functionalized dendrimers in separation columns serve as high-performance stationary phases in analytical separations. The dendrimers are preferably attached as stationary phases in columns incorporating the desired terminal groups.

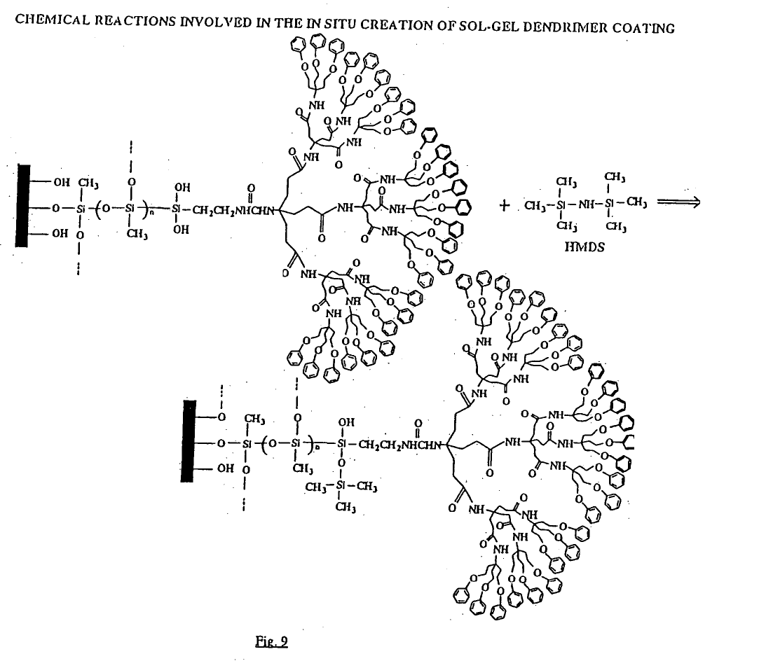

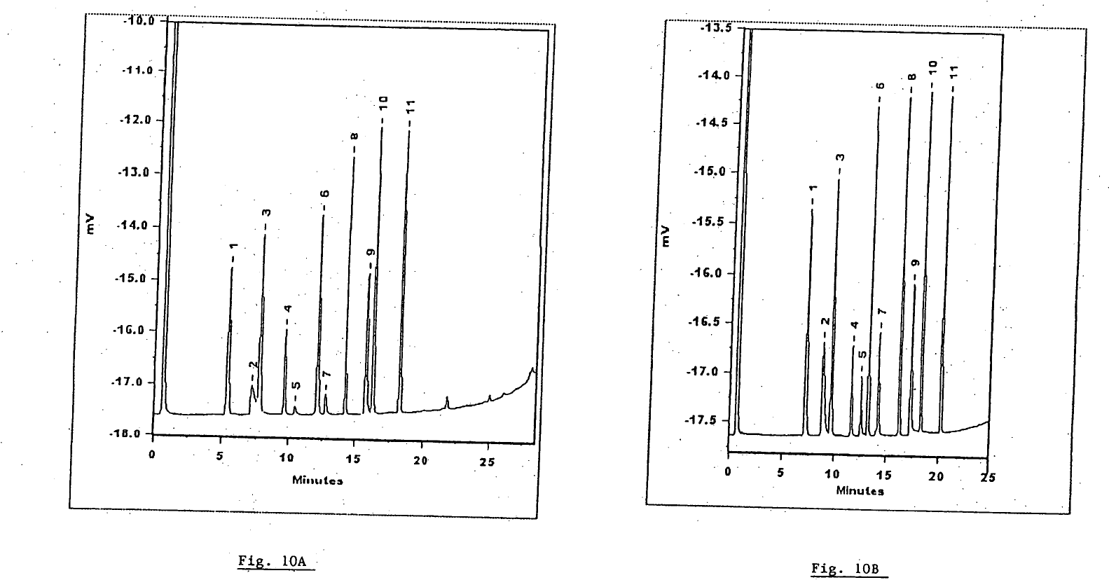

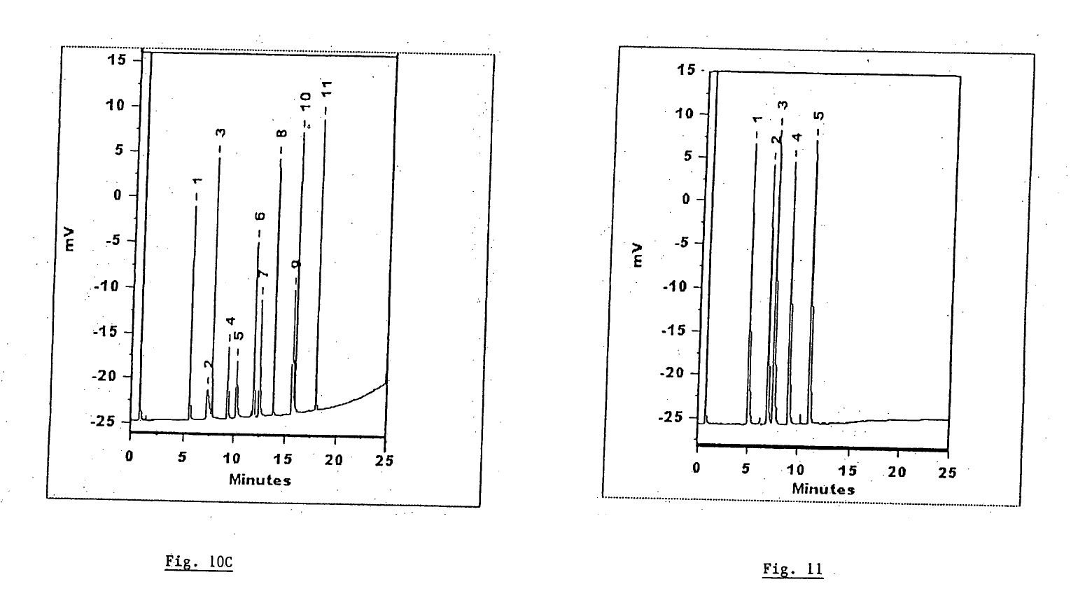

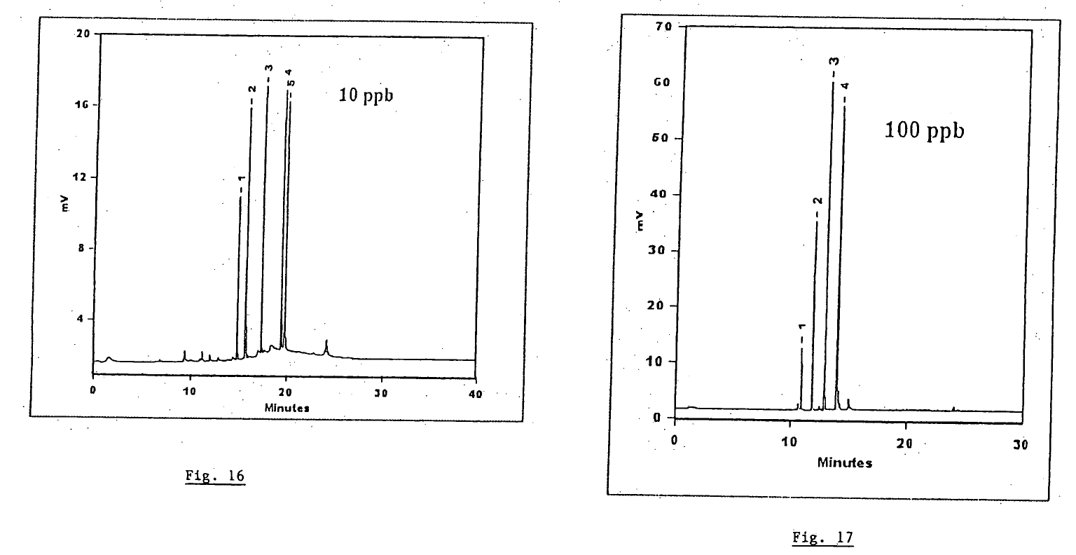

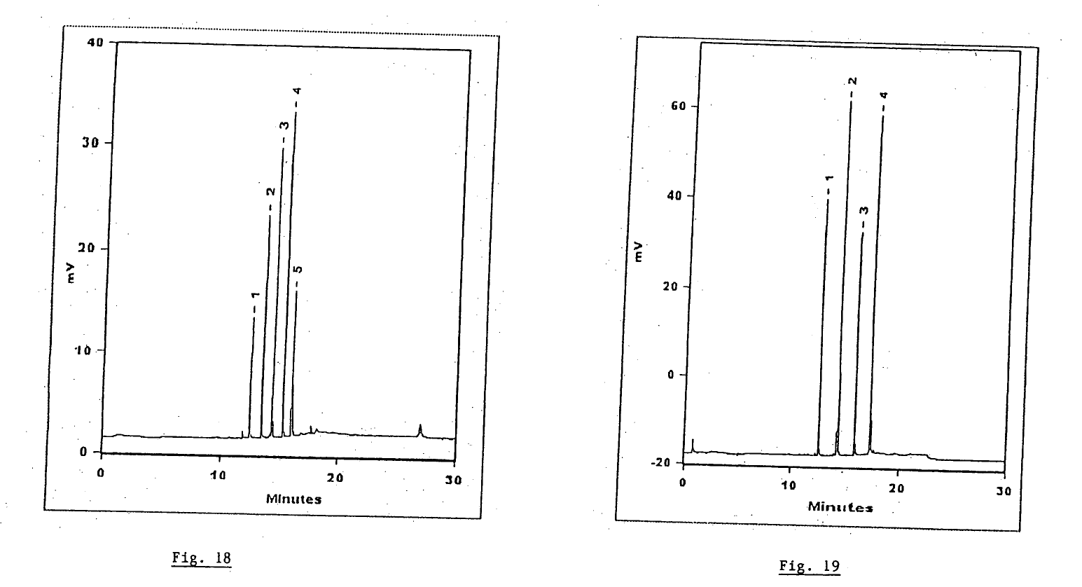

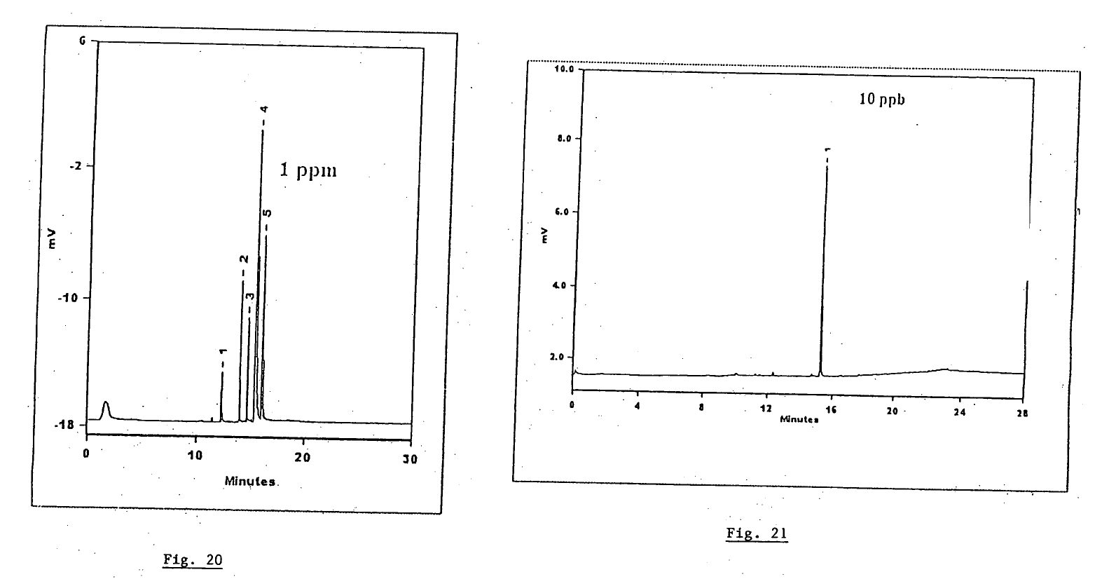

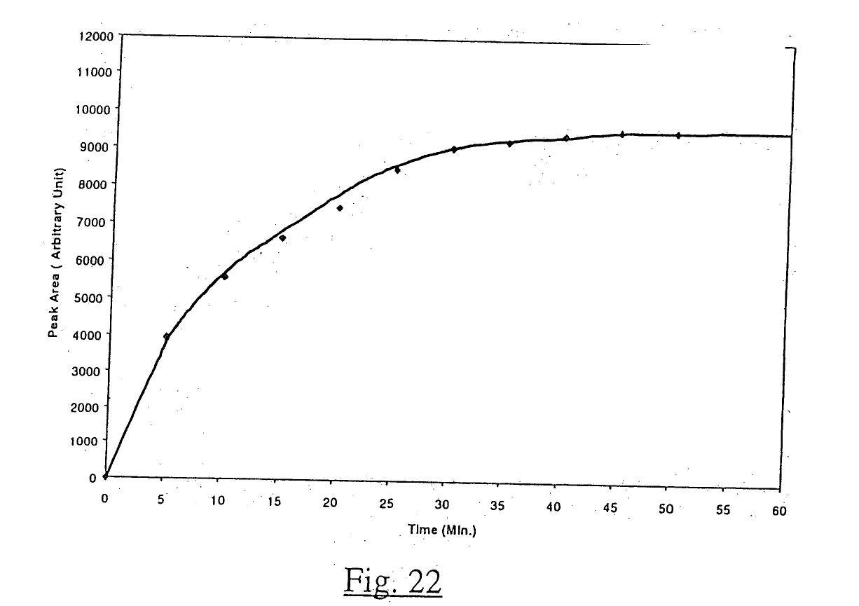

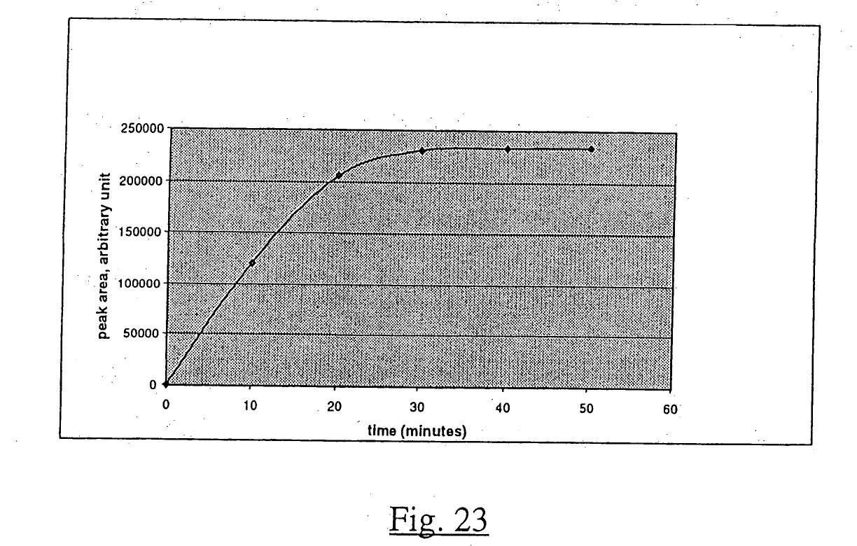

The present invention is useful for capillary systems as well as any other chromatography system that employs the use of polysiloxane-based, PEG-based, and other types of stationary phases for separation. The present invention has numerous applications and uses. Primarily, the present invention is useful in separation processes involving analytes including, but not limited, to hydrocarbons, polycyclic aromatic hydrocarbons (PAHs), alcohols, aldehydes, ketones, phenols, fatty acids, fatty acid methyl esters, amines, and other analytes known to those of skill in the art. The capillary column 10 of the present invention can be used for both gas chromatographic separations and for solventless sample preconcentration via capillary microextraction. For instance, FIGS. 10 to 15 illustrate the use of the capillary column 10 of the present invention for GC separations, while FIGS. 16 to 21 illustrate applications of capillary column 10 for sample microextraction or preconcentration. Further, capillary microextraction kinetics are illustrated in FIGS. 22 and 23. Additionally, as shown in Tables 1 and 2, low parts per trillion detection limits can be obtained for various classes of compounds by capillary microextraction using the capillary column 10 of the present invention. Accordingly, the present invention is useful in chemical, petrochemical, environmental, pharmaceutical applications, and other similar applications.

The present invention has various advantages over the prior art. In addition to increased selectivity and performance, the present invention provides for a fast way of surface roughening, deactivation, coating, and stationary phase immobilization—all carried out in a single step. Unlike conventional column technology in which these procedures are carried out as individual, time-consuming, steps, the present invention can achieve all of these just by filling a capillary with a sol-gel dendritic solution of appropriate composition, and allowing it to stay inside the capillary for a controlled period, followed by inert gas purging and conditioning of the capillary. The present invention greatly simplifies the methodology for the preparation of high efficiency GC columns, and offers an opportunity to reduce the column preparation time at least by a factor of ten. Being simple in technical execution, the present invention is very suitable for automation and mass production. Columns prepared by the present invention provide significantly superior thermal stability due to direct chemical bonding of the stationary phase coating to the capillary walls. Enhanced surface area of the columns provides a sample-capacity advantage to the sol-gel columns. The present invention provides excellent surface deactivation quality, which is either comparable with or superior to that obtained by conventional techniques. This is supported by examples of high efficiency separations obtained for polar compounds including free fatty acids, amines, alcohols, diols, phenols, aldehydes and ketones. The sol-gel dendrimer capillary column has the potential to offer a viable alternative to existing methods for column preparation in analytical microseparation and/or microextraction techniques.

The present invention has numerous embodiments, depending upon the desired application. As described below, the formation of the various embodiments are intended for use in gas chromatography. However, due to the vast applicability of the present invention, the column and related methods thereof can be modified in various manners for use in other areas of analytical separation, extraction, and/or pre-concentration technologies. The principles of the present invention can also be used to form capillary columns for use in liquid chromatography, capillary electrochromatography, supercritical fluid chromatography, and as sample pre-concentrators where a compound of interest is present in very small concentrations in a sample.

The present invention can be utilized any type of structure having a surface that is capable of being coated by the sol-gel dendrimer coating of the present invention. The structure can include, but is not limited to, a tube, a planar surface, a sphere, a plate, a coiled surface, a ring, an enclosed structure, an unenclosed structure, and any other structure having a suitable surface capable of being coated by the sol-gel dendrimer coating. Furthermore, any portion of the surface (i.e., exterior and/or interior) of the structure can be coated with the sol-gel dendrimer coating of the present invention. For example, an interior or exterior portion of a tube can be coated. Alternatively, two separate plates can be coated with the sol-gel dendrimer coating on a portion of a surface of each plate. Then, the plates can be sandwiched together to create a void or interior region for use in separations and/or extractions. With regard to the material of the structure, it can be made of any type of silica, glass, metal, alumina, fused silica, titania, zirconia, polymeric hollow fibers, and any other similar materials known to those of skill in the art.

In all of the embodiments of the present invention, there are two main components: (1) a sol-gel substrate 18 formed from sol-gel precursors that is attached to a portion of a surface 14 of a structure 12; and (2) a dendrimer mechanism 20, substrate 20, or moiety 20 formed from an isocyanate monomer. The dendrimer mechanism 20, substrate 20, or moiety 20 is bonded to the sol-gel substrate 18 and provides for a mechanism that selectively binds to various ligands, analytes, components, and other substances known to those of skill in the art.

(1) Sol-gel Substrates and Related Sol-gel Pre-cursors:

In the present invention, a sol-gel substrate is utilized. The sol-gel substrate, has the formula: 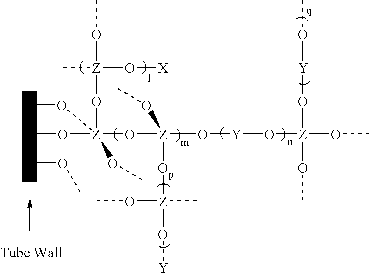
wherein,
X=Residual of a deactivation reagent (e.g., polymethylhydrosiloxane (PMHS), hexamethyldisilazane (HMDS), etc.);
Y=Sol-gel reaction residual of a sol-gel active organic molecule (e.g., molecules with hydroxysilane or alkoxysilane monomers, polydimethylsiloxane (PDMS), polymethylphenylsiloxane (PMPS), polydimethyldiphenylsiloxane (PDMDPS), polyethylene glycol (PEG) and related polymers such as Carbowax 20M, polyalkylene glycol such as Ucon, macrocyclic molecules such as cyclodextrins, crown ethers, calixarenes, alkyl moieties such as octadecyl, octyl, a residual from a baseline stabilizing agent such as bis(trimethoxysilyiethyl)benzene, 1,4-bis(hydroxydimethylsilyl)benzene, etc.
Z=Sol-gel precursor-forming chemical element (e.g., Si, Al, Ti, Zr, etc.)
I=An integer≧0;
m=An integer≧0;
n=An integer≧0;
p=An integer≧0;
q=An integer≧0; and
l, m, n, p, and q are not simultaneously zero.

Dotted lines indicate the continuation of the chemical structure with X, Y, Z, or Hydrogen (H) in space.

In the preparation of gas chromatography columns, it is desirable to use sol-gel solutions to coat the walls of capillary tube structures for the separation of analytes. These sol-gels are prepared by standard methods known in the art and comprise both polysiloxane and non-polysiloxane type gels. These include, but are not limited to, polysiloxane-based gels with a wide range of substituted functional groups, including: methyl, phenyl, cyanoalkyl, cyanoaryl, etc. In addition, sol-gel polyethylene glycols such as, but not limited to, PEG, Carbowax, Superox, sol-gel alkyl, sol-gel polyalkylene oxides, such as Ucon, and other sol-gels, such as sol-gel dendrimers can be modified by the instant invention.

In order to achieve the desired sol-gels of the instant invention, certain reagents in a reagent system were preferred for the fabrication of the gels for the columns of the present invention. The reagent system included two sol-gel precursors, a sol-gel active polymer or ligand, a deactivation reagent, one or more solvents and one or more a catalysts. For the purposes of this invention, the precursors utilized for preparing the sol-gel coated GC capillary columns of the present invention have the general structure of: 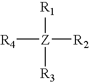
wherein,
Z is the precursor-forming element taken from a group including, but
not limited to, silicon, aluminum, titanium, zirconium, vanadium, germanium, and the like; and
R₁, R₂, R₃, and R₄ (i.e., “R-groups”) are substituent groups at least two of which are sol-gel-active, wherein the sol-gel active groups include, but are not limited to, alkoxy, hydroxy moieties, and the like. Typical sol-gel-active alkoxy groups include, but are not limited to, a methoxy group, ethoxy group, n-Propoxy group, iso-Propoxy group, n-butoxy group, iso-butoxy group, tert-butoxy group, and any other alkoxy groups known to those of skill in the art.

If there are any remaining R-groups, they can be any non sol-gel active groups such as methyl, octadecyl, phenyl, and the like. It is preferred however, that three or four of the R-groups are sol-gel active groups.

Typical non-sol-gel-active substituents of the precursor-forming element include, but are not limited to, alkyl moieties and their derivatives, alkenyl moieties and their derivatives, aryl moieties and their derivatives, arylene moieties and their derivatives, cyanoalkyl moieties and their derivatives, fluoroalkyl moieties and their derivatives, phenyl moieties and their derivatives, cyanophenyl moieties and their derivatives, biphenyl moiety and its derivatives, cyanobiphenyl moieties and their derivatives, dicyanobiphenyl moieties and their derivatives, cyclodextrin moieties and their derivatives, crown ether moieties and their derivatives, cryptand moieties and their derivatives, calixarene moieties and their derivatives, liquid crystal moieties and their derivatives, dendrimer moieties and their derivatives, cyclophane moieties and their derivatives, chiral moieties, polymeric moieties, and any other similar non-sol-gel active moieties known to those of skill in the art.

In addition to the above mentioned and preferred precursors, other precursors can be used with the present invention. These precursors include, but are not limited to, a chromatographically active moiety selected from the group of octadecyl, octyl, cyanopropyl, diol, biphenyl, and phenyl. Other representative precursors include, but are not limited to, Tetramethoxysilane, 3-(N-styrylmethyl-2-aminoethylamino)-propyltrimethoxysilane hydrochloride, N-tetradecyldimethyl(3-trimethoxysilylpropyl)ammonium chloride, N-(3-trimethoxysilylpropyl)-N-methyl-N,N-diallylammonium chloride, N-trimethoxysilylpropyltri-N-butylammonium bromide, N-trimethoxysilylpropyl-N,N,N-trimethylammonium chloride, Trimethoxysilylpropylthiouronium chloride, 3-[2-N-benzyaminoethylaminopropyl]trimethoxysilane hydrochloride, 1,4-Bis(hydroxydimethylsilyl)benzene, Bis(2-hydroxyethyl)-3-aminopropyltriethoxysilane, 1,4-bis(trimethoxysilylethyl)benzene, 2-Cyanoethyltrimethoxysilane, 2-Cyanoethyltriethoxysilane, (Cyanomethylphenethyl)trimethoxysilane, (Cyanomethylphenethyl)triethoxysilane, 3-Cyanopropyldimethylmethoxysilane, 3-Cyanopropyltriethoxysilane, 3-Cyanopropyltrimethoxysilane, n-Octadecyltrimethoxysilane, n-Octadecyldimethylmethoxysilane, Methyl-n-Octadecyldiethoxysilane, Methyl-n-Octadecyidimethoxysilane, n-Octadecyltriethoxysilane, n-Dodecyltriethoxysilane, n-Dodecyltrimethoxysilane, n-Octyltriethyoxysilane, n-Octyltrimethoxysilane, n-Ocyidiisobutylmethoxysilane, n-Octylmethyldimethoxysilane, n-Hexyltriethoxysilane, n-isobutyltriethoxysilane, n-Propyltrimethoxysilane, Phenethyltrimethoxysilane, N-Phenylaminopropyltrimethoxysilane, Styrylethyltrimethoxysilane, 3-(2,2,6,6-tetramethylpiperidine-4-oxy)-propyltriethoxysilane, N-(3-triethoxysilylpropyl)acetyl-glycinamide, (3,3,3-trifluoropropyl)trimethoxysilane, (3,3,3-trifluoropropyl)methyldimethoxysilane, 3-mercaptopropyltrimethoxysilane, , 3-mercaptopropyltrimethoxysilane, 3-mercaptopropyltriethoxysilane, mercaptomethylmethyldiethoxysilane, 3-mercaptopropylmethyldimethoxysilane, 3-mercaptopropyloctadecyidimethoxysilane, 3-mercaptopropylloctyldimethoxysilane, 3-mercaptopropylcyanopropyldimethoxysilane, 3-mercaptopropyloctadecyldiethoxysilane, and any other similar precursor known to those of skill in the art.

The deactivation reagents include, but are not limited to, hydrosilanes, polymethylhydrosiloxianes, polymethylphenyl hydrosiloxanes, polymethyl cyanopropyl hydrosioloxanes, and any other similar deactivation reagent known to those of skill in the art. The primary catalyst includes, but is not limited to, trifluoroacetic acid, any acid, base, fluoride, and any other similar catalyst known to those of skill in the art.

In addition to the above-mentioned materials, the performance of the sol gel stationary phase can be improved by the addition of at least one baseline stabilizing reagent and at least one additional surface deactivation reagent to the sol-gel solution. The baseline-stabilizing reagent prevents rearrangement of the sol-gel polymeric stationary phase and formation of volatile compounds at elevated temperature. In order to do so, the baseline-stabilizing reagent incorporates with the phenyl ring in the polymer backbone structure at room temperature using a sol-gel process. The baseline-stabilizing reagent includes, but is not limited to, bis(trimethoxysilylethyl)-benzene (BIS), phenyl-containing groups, cyclohexane containing groups, and any other similar sol-gel active stabilizing reagent known to those of skill in the art. In one embodiment, the baseline-stabilizing reagent is used in conjunction with methyltrimethoxysilane (a sol-gel precursor), and two sol-gel catalysts (trifluoroacetic acid and ammonium fluoride). First the sol-gel reactions are carried out for ten minutes using trifluoroacetic acid as the primary catalyst. After this, a second sol-gel catalyst is used to improve the condensation process for the sol-gel coating and its bonding with the capillary inner surface. The second sol-gel catalyst includes, but is not limited to, ammonium fluoride, base, fluoride, and any other similar catalysts known to those of skill in the art. It is known that under acidic conditions the hydrolysis reaction proceeds faster to produce primarily linear polymeric structure, but the polycondensation reaction remains slow. The addition of fluoride increases the polycondensation reaction rate.

Finally, a surface derivatization reagent can be added as a secondary deactivation reagent, which includes, but is not limited to, 1,1,1,3,3,3-heaxmethyldisilazane, any hydrosilane, and any other similar surface deactivation reagents known to those of skill in the art. The sol-gel reactions involved in the formation of the sol-gel structure and resulting sol-gel and dendrimer substrate described herein and chemical bonding of the sol-gel and dendrimer substrate to a portion of the inner surface of the capillary column are illustrated in the Figures.

The preparation of the sol-gel coating includes the steps of providing the tube structure, providing a sol-gel solution including one or more sol-gel precursors, an organic material with at least one sol-gel active functional group, one or more sol-gel catalysts, one or more deactivation reagents, and a solvent system. The sol-gel solution is then reacted with a portion of the tube (e.g., inner surface) under controlled conditions to produce a surface bonded sol-gel coating on the portion of the tube. The free portion of the solution is then removed from the tube under pressure, purged with an inert gas, and is heated under controlled conditions to cause the deactivation reagent to react with the surface bonded sol-gel coating to deactivate and to condition the sol-gel coated portion of the tube structure. Preferably, the sol-gel precursor includes an alkoxy compound. The organic material includes a monomeric or polymeric material with at least one sol-gel active functional group. The sol-gel catalyst is taken from the group consisting of an acid, a base and a fluoride compound, and the deactivation reagent includes a material reactive to polar functional groups (e.g., hydroxyl groups) bonded to the sol-gel precursor-forming element in the coating or to the tube structure.

(2) Dendrimer and Isocyanate Monomer:

The dendrimers utilized with the present invention have been prepared according to the procedures and examples presented in U.S. Pat. No. 5,136,096 to Newkome et al., U.S. Pat. No. 5,650,101 to Newkome et al., U.S. Pat. No. 5,703,271 to Newkome et al., and U.S. Pat. No. 5,773,551 to Newkome et al., all of which are incorporated herein by reference in their entirety. Specifically, the dendrimer is a cascade molecule or isocyanate monomer synthesized by reacting at least one tier of a functionalized structure with compounds of the type:
O═C═N—C (CH₂R)₃
   with R being selected from the group including, but not limited to,
a) —CH₂-tbu
b) —(CH₂)ₙ—CH₂—COOR′
   with n=0-10 and R′ including, but not limited to, alkyl, cycloalkyl, aryl, heteroaryl, polycycloalkyl, and adamantyl;
c) —O—(CH₂)ₙ—CH₂—COOR′
   with R′ being selected from the group consisting of alkyl (C-1 to C-20), cycloalkyl (C-3 to C-10), aryl heteroaryl, polycycloalkyl, adamantyl, n=0-10;
d) —O—(CH₂)ₙ—CH₂—CN
e) —(CH₂)ₙ—CH₂—O—R″
   with n=0-10 and R″ selected from the group including, but not limited to, alkyl, cycloalkyl, aryl heteroaryl ester functionality, and a sulfur or a silicon atom bearing substituents selected from the group including:
—C(═O)X, —C(═S)X, —SO₂—R″′, —SiR₃″′
—(CH₂)ₙ—CH₂—CN, —(CH₂)ₙ—CH₂—COOR″′
   wherein R″′is alkyl (C-1 to C-20), cycloalkyl (C-3-C-10), aryl, heteroaryl,

polycycloalkyl, adamantyl, n=0-10.

Specific examples of the aforementioned R groups are
R=CH₂CH₂CO₂R′
OCH₂CH₂CO₂R′
OCH₂CH₂CN
OCH₂CH₂CH₂OR″
OCH₂CH₂CH₂NR′R″′
OCH₂CH₂CH₂SR″
OCH₂CO₂R′
CH₂CH₂NR′₂
CH₂CH₂SR′

The dendrimer or isocyanate monomer can be single or multi-branched. Additionally, it can have numerous functions including, but not limited to, being a selective micelle for selectively attaching to a ligand and a lock and key micelle. In the lock and key micelle scenario, the micelle includes an acceptor region being disposed within an engineered void region to define a pocket that allows entrance thereto of a specific ligand based on the ligands' structure and a binding region that is complementary to the acceptor region.

More specifically, referring to cascade molecules or polymers, such cascade molecules can be used to provide a (uni)molecular micelle including internal void areas, the void areas including reactive sites capable of covalent and non-covalent bonding to guest(s). Such (uni)molecular micelles made in accordance with the present invention are cascade structures that act as micelles. Such molecules are essentially all alkyl molecules having a nitrogen or carbon core or branching site. Such compounds have predefined branching, depending upon the number of sequential “tier” additions that are performed. That is, the synthetic process is a matter of assembling the molecule in tiers or layers in accordance with the inventive method described herein.

The etymology of the term “Micelle”, as employed in the classical or usual sense refers to a non-covalently associated collection (aggregate) of many simple molecules functioning as a unit having unique properties (for example, aqueous solubilization of water in soluble materials) that are not observed with the individual molecules that comprise the micelle. Whereas, as used herein, (uni)molecular micelle refers to a single macromolecule, possessing a covalently constructed superstructure that can perform the same function or functions as a classical micelle.

Most generally, micelles or cascade polymers made in accordance with the present invention can be described as having at least one core atom, preferably a carbon atom, and arms branching from the core atom. In the synthesis of cascade polymers, cascade refers to the tiering or layer-wise addition of monomers or “building blocks” that eventually comprise the resulting unimolecular micelle. These monomers or building blocks instill (1) a primary structure attributed to nuclei-connectivity; (2) a secondary structure attributed to fundamental nuclei interaction such as hydrogen binding, dipole interactions, and London forces; (3) a tertiary structure that can assume molecular shapes such as ribbons, zippers, threads, and spheres which are internal and external conformations induced by a secondary structure; and (4) a dynamic, structured void domain or “quasi-tertiary” structure of the unimolecular micelle determined by the combination of the primary, secondary and tertiary structures. A quasi-tertiary domain comprises one of the major domains of the micellar macromolecular structure that includes the immediate region above the micellar surface, the micellar per se and the micellar framework. All of these domains are active in that they can be used to effect chemical and physical changes of the (uni)molecular micelle, its environment, a molecular guest or guests, or any of the cited combinations.

Termination of the arms of the micelles, or with larger branching, possibly mid-portions of the arms, may fold to form an outer surface of the micelle or cascade structure. The surface of the micelle is exposed to the immediately surrounding environment in which the micelle is disposed. This environment will have a certain hydrodynamic character, determined by properties such as pH, lipophilicity-hydrophilicity characteristics. Such surface characteristics also lead to general solubility of the micelle, even when carrying a relatively insoluble guest therein. Such surfaces can be readily coated with metal ions. Thus, incorporation of specific types of metals or nonmetals within the chemically accessible lipophilic interior of the unimolecular micelle can also be achieved.

Synthesis of Sol-gel Dendrimer Coating or Matrix:

Synthesis of the combined sol-gel dendrimer coating 16 or matrix 16 is described in more detail in the examples section and illustrated in the Figures. Generally, synthesis occurs by reaction of the various dendritic reagents or isocyanate monomers (Structure 2, Structure 7, and Structure 12, respectfully) with a sol-gel substrate 18 such as 3-triethoxysilylpropylamine. Preferably, the dendritic reagent or isocyanate monomer possesses a focal isocyanate moiety and terminal benzyloxy groups.

### EMBODIMENTS OF THE PRESENT INVENTION

In an embodiment of the present invention (FIG. 1), the sol-gel dendron separation and extraction capillary column 10 includes the tube structure 12 having the inner surface 14 and a sol-gel dendrimer stationary phase coating 16. The sol-gel dendrimer coating 16 is attached to the inner surface 14 by means of the sol-gel substrate 18. In this embodiment, the dendrimer is an isocyanate monomer having a terminal benzyl ether group attached thereto. Depending upon the desired selectivity, the number of benzyl ether groups varies accordingly and extensive branching can occur.

The tube structure 12 of the capillary column 10 can have any shape including, but not limited to, cylindrical, spherical, conical, funnel-shaped, pyramid-shaped, polygonal-shaped, coiled, elongate-quadrangular-shaped, oblong, and any other similar shape known to those of skill in the art. The tube structure 12 can be made of numerous materials including, but not limited to alumina, fused silica, glass, titania, zirconia, polymeric hollow fibers, and any other similar tubing materials known to those of skill in the art. Typically, fused silica is the most convenient material used. Sol-gel chemistry in analytical microseparations and/or microextractions. presents a universal approach to creating advanced material systems including those based on alumina, titania, and zirconia that have not been adequately evaluated in conventional separation column technology. Thus, the sol-gel chemistry-based column technology has the potential to effectively utilize advanced material properties to fill this gap.

The sol-gel dendrimers or various polysiloxane-based materials are attached to a GC column. In this embodiment, the various materials that are most commonly used as stationary phases in GC are prepared by chemically binding functional pendant groups to a polysiloxane backbone. The pendant groups used include, but are not limited to, methyl, phenyl, biphenyl, cyanopropyl, cyanobiphenyl, dicyanobiphenyl, liquid crystalline moieties, chiral moieties, and molecular cavities including cyclodextrins, crown ether, calixarenes, and cyclophanes. Non-silicone stationary phases used include, but are not limited to, polyethylene glycols and molten salts of various organic acids.

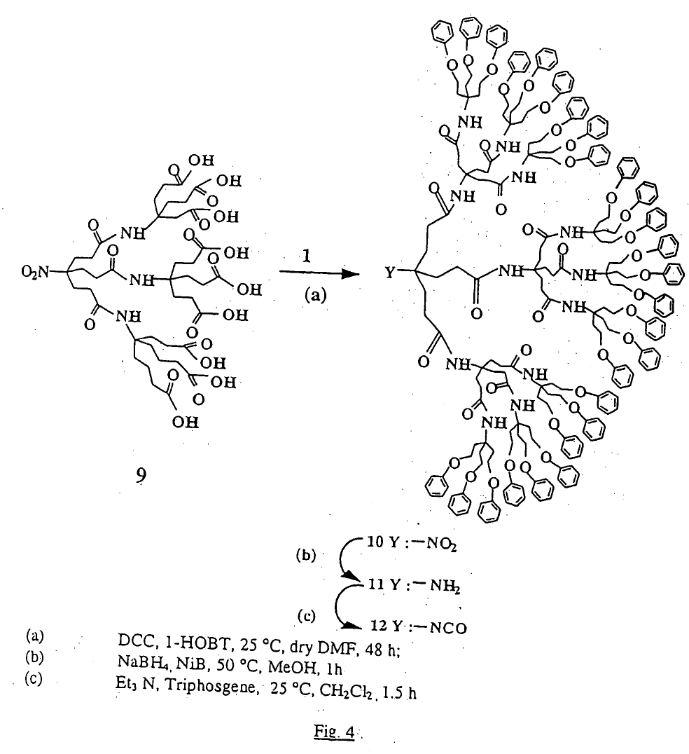

The formation of the initial isocyanates has been previously reported by the simple reduction of the alkyl nitro group to the corresponding amine, which with triphosgene generates in high overall, yields the desired isocyanate (Scheme 1) (See also, isocyanate monomers section above, Newkome et al., 1997A, Newkome et al., 1997B, U.S. Pat. Nos. 5,703,271, 5,773,551, 5,886,126, and 5,886,127). The 1-3 branched monomers are generally stable and many are stable, colorless crystalline materials. Isocyanate monomers, having terminal benzyl ether moiety, are utilized as depicted in Schemes 2 and 3, FIGS. 3 and 4 respectively. A larger structure, 9-benzyl ether (Structure 5), and even larger analogue (Structure 10) were synthesized from Structure 4 and Structure 9 (Newkome et al., 1991) respectively, by reacting each with 4-amino-4-[3-(benzyloxy)propyl]-1,7-di(benzyloxy)heptane (Newkome et al., 1992) using DCC coupling in anhydrous DMF at 25° C. for 48 hours. The formation of Structure 5 and Structure 10 are confirmed by the upfield shift of carbonyl carbon, confirming the acid to amide conversion, and the downfield shift (¹³C NMR: Δ 5˜6 ppm) of the C^{4°} —NH₂. The identification of both structures was further supported by the peaks at m/z 1673.1 [M+Na⁺] (5: calcd. m/z 1673.2 [M+Na⁺} and m/z 5106.6 [M+Na⁺] (10: calcd. m/z 5106.8 [M+Na⁺]) in ESI-MS and MALDI-TOF, respectively.

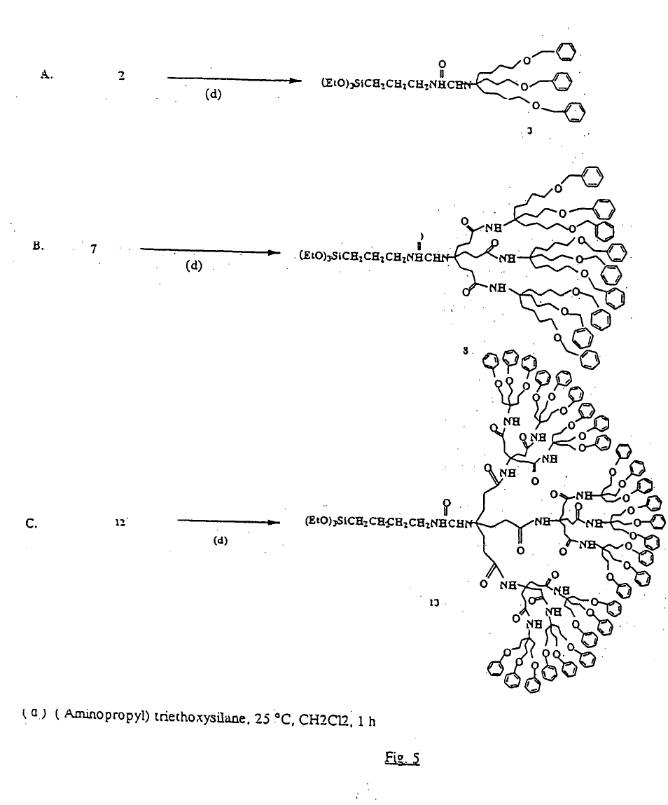

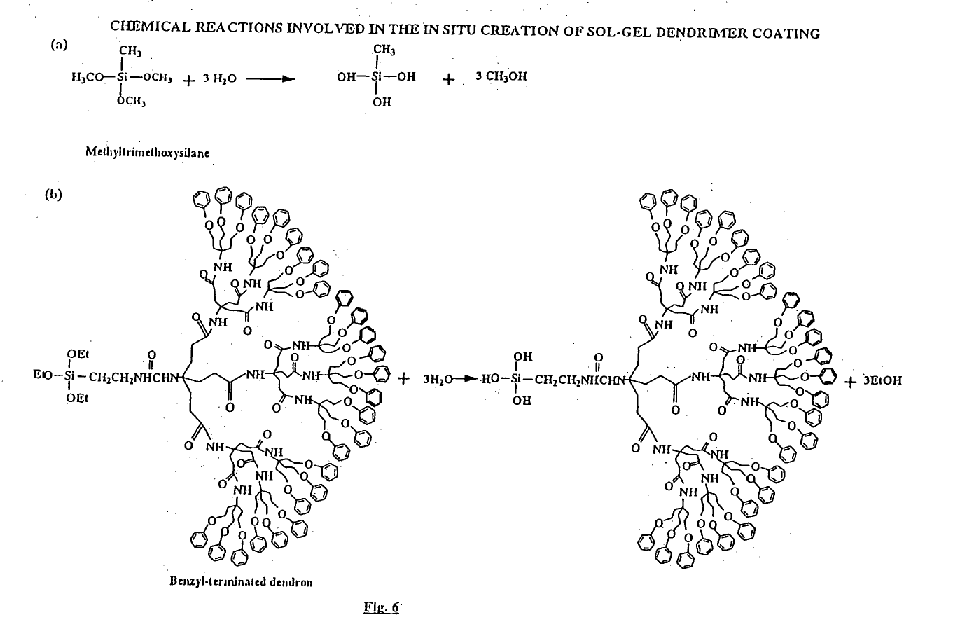

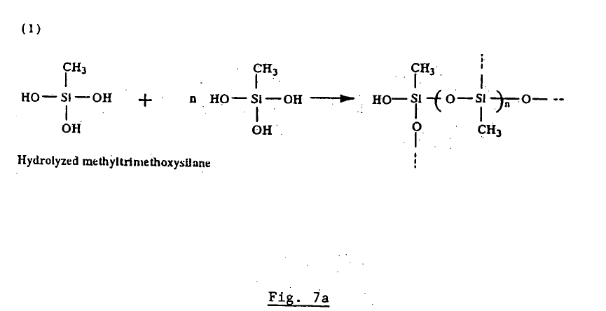

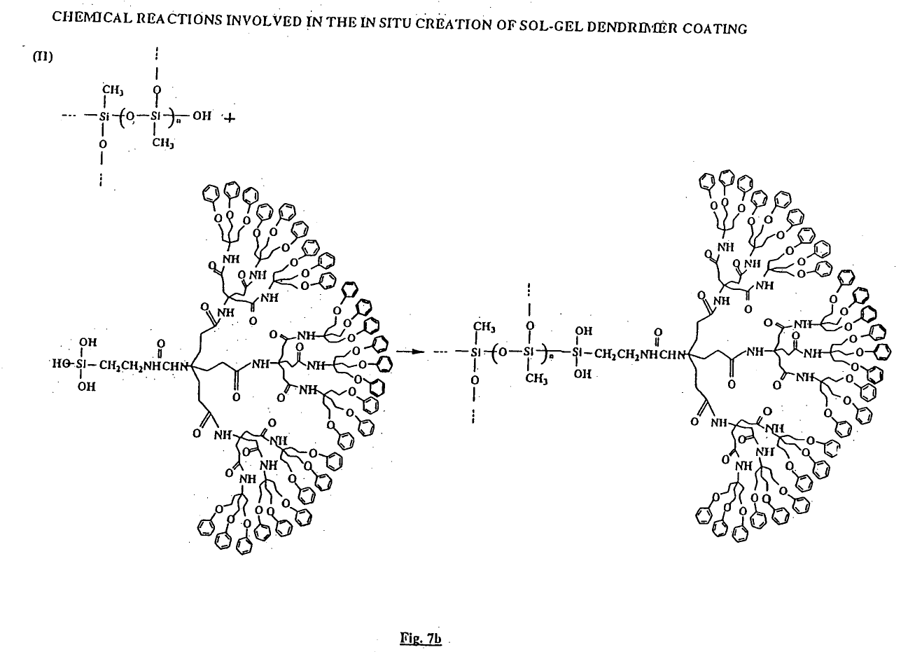

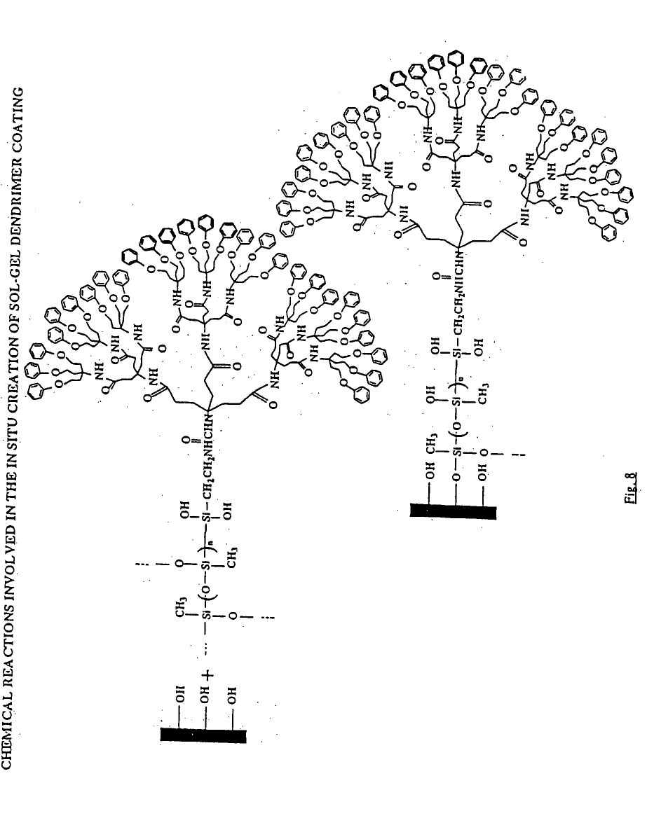

Reduction of the nitro moieties for Structure 5 and Structure 10, as depicted in FIGS. 3 and 5 respectively, with NiB and NaBH₄ (Newkome et al., 1997A) in a MeOH-EtOH—C₆H₅Me mixture at 55° C. afforded the corresponding amines, Structure 6 and Structure 11 respectively. These structures are identified by the traditional chemical shift (¹³C NMR) for C^{4°} from 92.4(5) and 93.1 (10) ppm to 52.6 (6) and 49.3 (11) ppm, respectively, confirming the desired C^{4°}—NO₂ to C^{4°}—NH₂ transformation.

Treatment of these amines, either Structure 6 or Structure 11, with 0.4 equivalent of triphosgene, phosgene, or phosgene equivalents in the presence of Et₃N in CH₂Cl₂ gives the corresponding isocyanate, Structure 7 or Structure 12, respectively. These structures are confirmed (¹³C NMR) by chemical shift from 52.6 and 49.3 ppm to 61.9 and 60.3 ppm, respectively, for the C^{4°}—NH₂ to C^{4°}—NCO conversion as well as the new peak at ca. 122 ppm for the NCO group. Furthermore, the IR spectrum for each showed the typical isocyanate peak at 2257 and 2248 cm⁻¹ and the ESI-MS and MALDI-TOF further confirms their assignment by a peak at m/z 1646.2 [M⁺] (7: calculated. m/z 1646.2 [M⁺]) and m/z 5080.2 (12: calculated. m/z 5080.8 [M+H⁺]), respectively.

Dendritic silane reagents (Structure 3, Structure 8, and Structure 13) are synthesized by treatment of these monomers possessing the focal isocyanate moiety and terminal benzyloxy groups with 3-triethoxysilylpropylamine in dry CH₂Cl₂ at 25° C. for 1 hour. The preparation of Structure 3, Structure 8, and Structure 13 are confirmed (¹³C-NMR) by the presence of a new urea (NHCONH) carbon peak at ca. 157 ppm, as well as (IR) a new absorbance peaks at 1100 and 1650 cm⁻¹ for the silane group (Si—O) and urea carbonyl group. There is no absorbance peak (2250 cm⁻¹) indicative of the —NCO moiety.

These dendritic reagents contain the desired triethoxysilyl group, which makes them sol-gel active. MTMS is a second sol-gel active ingredient in the solution. Under the experimental conditions, the sol-gel active dendritic reagents (Structure 2, Structure 7, or Structure 12) and MTMS undergo hydrolysis catalyzed by TFA. The hydrolyzed products further undergo polycondensation reaction to form an organic-inorganic hybrid polymer network with the dendrimers, as the organic constituents do. The condensation reaction can also take place with the participation of the silanol groups on the inner surface of the fused silica capillary. The sol-gel dendritic network developed in the vicinity of the fused silica capillary inner surface get chemically anchored to the column walls forming a surface-bound stationary phase film, and remain as such when the sol-gel solution is expelled after 15 minutes of residence inside the capillary. Polymethylhydrosiloxane (PMHS) used in the coating solution is not sol-gel active. The physically incorporated molecules of this material deactivate the column by reacting with the residual silanol groups on the coated surface during the thermal conditioning that follows the coating process. The sol-gel procedure elegantly combines column deactivation, coating and stationary film immobilization in a simple and effective manner.

FIGS. 10A, 10B, and 10C present three gas chromatograms obtained on three different sol-gel columns with the first- (2)(A), second- (7) (B), and third (12) generation (C) benzyl- terminated dendritic appendages, as part of the stationary phases. Grob test mixture (Grob et al.) containing compounds from different chemical classes was used as the sample probe. As can be seen in FIGS. 10A, 10B, and 10C, the sol-gel dendrimer stationary phase can provide well-behaved chromatographic peaks for both polar and non-polar components. The elution pattern for individual components of this mixture is very different from that obtained on conventional columns. For example, unlike conventional PDMS or related capillary GC columns that produce 2,3-butanediol as the first peak under the standard operating conditions on phenyl-terminated sol-gel dendrimer columns, the first eluting component is n-decane. In this respect, the sol-gel dendrimer column behaves similar to a polar column (e.g., PEG type) characterized by early elution of n-alkanes.

The chromatograms of FIGS. 10A, 10B, and 10C reveal that compared with conventional PDMS column, the sol-gel dendrimer column provides a different elution order for all the peaks (except for methyldodecanoate, which elutes last in both cases). This unique selectivity of the sol-gel dendrimer stationary phase in GC is attributed to the unique molecular architecture of the dendritic stationary phase.

A marked difference in chromatographic efficiency is observed in columns prepared with sol-gel dendrimer stationary phases containing different generations of dendritic moieties. For example, an efficiency value of 3,200 theoretical plates/m is obtained on a 10 m×0.25 m i.d. column coated with the third generation sol-gel dendrimer stationary phase. This corresponded to a minimum plate height of 0.31 mm and an optimum flow rate of 25 cm/s. Efficiency values on the order of only 1,000 plates/m were obtained on the columns coated with the first and second generation stationary phases.

FIGS. 11 and 12 represent GC separations of aldehydes and ketones, respectively, on a phenyl-terminated third generation sol-gel dendrimer stationary phase. Sharp symmetrical peaks of the aldehyde and ketone peaks are indicative of quality deactivation and performance of the sol-gel dendritic stationary phase used. Analysis of aldehydes and ketones is important both from industrial and environmental points of view. HPC is frequently employed for this purpose (Koivusalmi et al.); however, HPLC analysis often requires a prior derivatization of the separation mixture making the analysis more complicated and time consuming. The UV detector frequently employed in HPLC is much less sensitive than the flame ionization detector used in GC analysis. This makes GC analysis of underivatized aldehydes and ketones more practical and attractive.

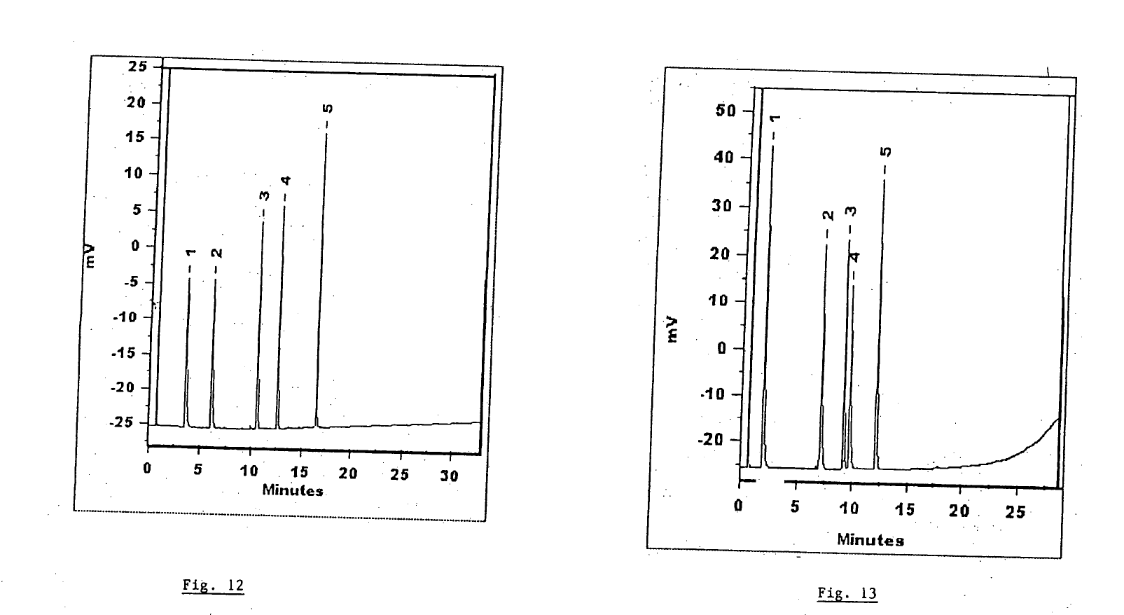

GC separation of a mixture of aromatic amines is represented in FIG. 13. Amines are prone to adsorption on chromatographic columns. The sharp, symmetrical peaks for the amine components are further evidence of the excellent deactivation quality of the newly developed sol-gel dendritic GC columns.

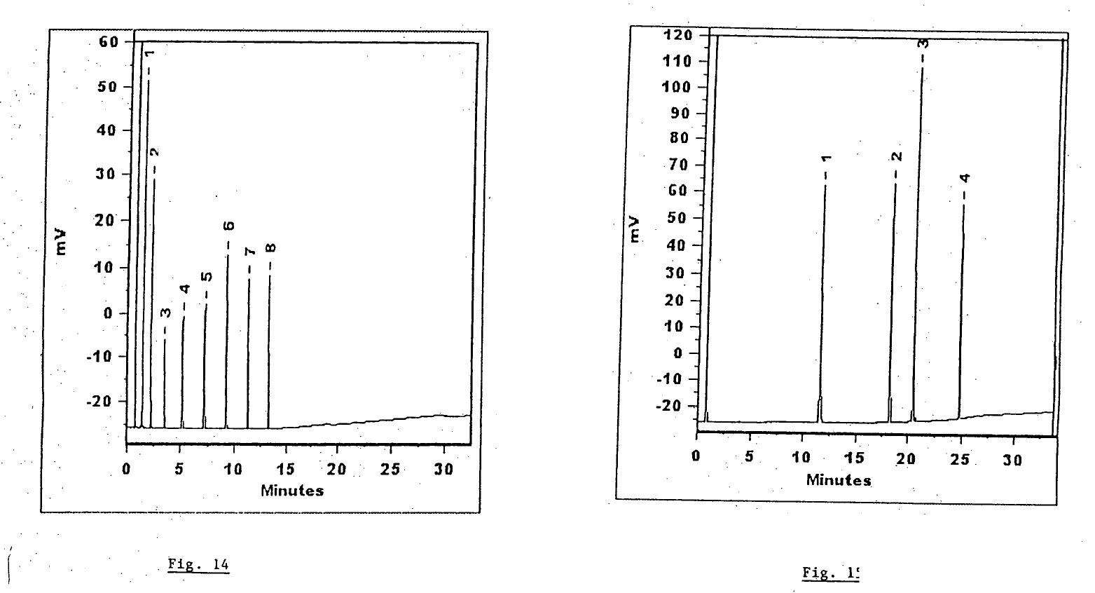

The chromatograms presented in FIGS. 10-13 illustrate the applicability of sol-gel dendritic columns for the separation of polar materials; however, these columns are also effective in the separation of nonpolar compounds as is exemplified by the separation of alkanes (FIG. 14) and polycyclic aromatic hydrocarbons (FIG. 15).

Because the dendritic reagent possessed simply benzyl ether termini and urea connectivity, it can be concluded that the dendritic architecture provides unique selectivity in capillary GC separations and makes these materials very useful in chromatographic and electromigration separations and/or extractions. In view of the easy ability to create diverse, useful canapes that can enshrine different specific functionality to achieve an appropriate chemical lock and key arrangement. Installation of these complimentary supramolecular relationships into the environment analyte species for chromatographic interactions can lead to enhanced selectivity in separations and/or extractions. The use of sol-gel chemistry to chemically bind these molecules to the capillary inner surface in the form of a stable organic-inorganic hybrid stationary phase coating opens new possibilities for enhanced performance and stability in differential migration separation and/or extraction techniques.

The specific steps for fabrication starts with the cleaning and hydrothermal treatment of a fused silica capillary. Then, the preparation of the sol-gel solution utilizing the above precursors is done. Next, the inner walls of the hydrothermally treated capillary column are coated with the prepared sol-gel solution. Finally, conditioning of the sol-gel coated capillary tube is performed.

The creation of a surface-bonded sol-gel dendrimer coating on the inner walls of a fused silica capillary involves the steps of (1) mixing suitable sol-gel precursor(s) and sol-gel active dendritic moieties to form a sol-gel solution; (2) hydrolyzing the sol-gel-active precursor(s) and dendritic moieties to form hydrolyzed products (Scheme 5); (3) polycondensating the hydrolyzed products into a sol-gel dendrimer network (Schemes 6a and 6b); and

(4) surface bonding the sol-gel dendrimer network on a portion of the capillary inner walls to form a surface bonded sol-gel dendrimer stationary phase coating thereon (Scheme 7).

Deactivation of the residual silanol groups on the surface coating is represented by Scheme 8. The hydrolysis and polycondensation reactions take place within the sol-gel solution placed inside the fused silica capillary, while the deactivation reaction takes place at elevated temperatures during the column conditioning carried out at a later step in the column preparation process. Additionally, the mixing step further includes adding trifluoroacetic acid as a catalyst alone, or in conjunction with an additional catalyst including, but not limited to, acids, bases, and fluorides.

The above discussion provides a factual basis for the use of the column and related method described herein. The methods used with a utility of the present invention can be shown by the following non-limiting examples and accompanying figures.

### EXAMPLES

The following examples specifically provide for the specific methods and materials utilized with the present invention.

Chemicals and Materials:

All of chemicals are from Aldrich Co., except for HPLC-grade CH₂Cl₂ and MeOH, which are from Fisher Scientific and methyltrimethoxysilane (MTMS), which is obtained from United Chemical Co. Dimethyl formamide (DMF) is dried (MgSO₄) and distilled in vacuo. All other commercial solvents are used without further purification. Column chromatography is conducted using neutral/basic alumina, Brockman Activity I, 60-325 mesh or silica gel (60-200 mesh) from Fisher Scientific. Fused silica capillary having a 250 μm internal diameter (i.d.) is from Polymicro Technologies. High purity deionized water (18 Ω) is prepared in-house from a Barnstead model 04741 Nanopure deionized water system. ¹H and ¹³C-NMR spectra are recorded at 250 and 52 MHz, respectively, on a Brucker AC 250 MHz spectrometer and are obtained in CDCl₃, unless otherwise stated. Infrared (IR) spectra are recorded on an ATI Mattson Genesis Series Fourier transform infrared spectrophotometer. Mass spectral data are obtained on an Esquire electron ionization mass spectrometer (ESI-MS) and MALDI-TOF. Gas chromatographic experiments are conducted on a Shimadzu 17 GC system equipped with a split/splitless injector and a flame ionized detector (FID). A Microcentaur APO 5760 centrifuge is employed for necessary centrifugation of the sol-gel solution. A Fisher Model G-560 Vortex Genie 2 system is used for thorough mixing of the sol-gel solution ingredients while preparing the sol-gel solution. A homemade gas-pressure operated filling/purging device (J. D. Hayes et al.) is used for filling the fused silica capillary with the sol-gel solution, as well as rinsing and purging with helium at various stages of column preparation.

Methods:

Method A (Formation of extended silyl reagent): Silane-3-benzyl ether (Structure 3)

The preparation and formation of an extended silyl reagent is described below. Specifically, a silane-3-benzyl ether (Structure 3) is initially formed.

To a solution of 4-isocyanato-4-[3-(benzyloxy)propyl]-1,7-di(benzyloxy)heptane (G. R. Newkome et al., 1997 A) (450 mg, 890 μmol) in dry CH₂Cl₂ (20 mL), 3-triethoxysilylpropylamine (215 μL, 890 μmol) is added. The mixture is stirred at 25° C. for one hour, after which the solvent is removed in vacuo. This material is column chromatographed (SiO₂) eluting with 66% EtOAc in hexane to yield (99%) Structure 3, as a colorless oil (650 mg): ¹H NMR δ 0.72 (t, 2H, SiCH₂CH₂CH₂, J=8.2 Hz), 1.33 (t, 9H, CH₃CH₂O, J=7.0 Hz), 1.66 (m, 14 H, SiCH₂CH₂CH₂, CH₂CH₂CH₂O), 3.13 (q, 2H, SiCH₂CH₂CH₂, J=6.4 Hz), 3.59 (t, 6H, CH₂CH₂CH₂O, J=6.4 Hz), 3.92 (q, 6H, CH₃CH₂O, J=7.0 Hz), 4.60 (s, 6H, OCH₂Ph), 7.43 (m, 15H, Ph); ¹³C NMR δ 7.4 (SiCH₂CH₂CH₂), 18.1 (CH₃CH₂O), 23.5 (CH₂CH₂CH₂O, SiCH₂CH₂CH₂), 30.7 (CH₂CH₂CH₂O), 42.4 (SiCH₂CH₂CH₂), 56.6 (NHCONHC), 58.1 (CH₃CH₂O), 70.7 (CH₂CH₂CH₂O), 72.7 (OCH₂Ph), 1.27.4, 128.1, 129.3, 138.2 (Ph), 156.9 (NHCONH); IR 3327, 3062, 3029, 2940, 2859, 2793, 1652, 1541, 1101 cm⁻¹; ESI-MS m/z=723.0 [M]; Calcd. m/z=723.1 [M].

Method B (Amidation): Nitro-9-benzyl ether (Structure 5)

Amidation method to form nitro-9-benzyl ether (Structure 5) from an acid (Structure 4). To a solution of acid (Structure 4) (1.00 g, 3.60 mmol) in dry DMF (50 mL), DCC (2.46 g, 11.84 mmol) and 1-HOBT (1.60 9, 11.84 mmol) at 25° C. are added. The solution is stirred for two hours, and then amine (Structure 1) (5.69 g, 11.96 mmol) is added. The stirred solution is maintained for 48 hours, after which a white precipitate is filtered. The filtrate is concentrated in vacuo to give a crude oil, which is column chromatographed (Al₂O₃) eluting with 5% EtOAc in hexane to yield (81%) (Structure 5), as a colorless oil: 4.81 g; ¹H NMR δ 1.59 (s, 18H, CH₂CH₂CH₂O), 1.78 (s, 18H, CH₂CH₂CH₂O), 2.01 (s, 6H, CH₂CH₂CONH), 2.19 (s, 6H, CH₂CH₂CONH), 3.50 (t, 18H, CH₂CH₂CH₂O, J=6.0 Hz), 4.54 (s, 18H, OCH₂Ph), 5.86 (s, 3H, CONH), 7.39 (m, 45H, Ph); ¹³C NMR δ 23.5 (CH₂CH₂CH₂O), 30.9 (CH₂CH₂CONH), 31.4 (CH₂CH₂CH₂O), 58.1 (CONHC), 70.4 (CH₂CH₂CH₂O), 72.7 (OCH₂Ph), 92.4 (O₂NC), 127.3, 127.5, 128.1, 138.1 (Ph), 170.0 (CONH); IR 3324, 3062, 3029, 2904, 2856, 1668, 1539, 1454, 1362, 1101 cm⁻¹; ESI-MS m/z=1673.1 [M+Na⁺]; calcd. m/z=1673.2 [M+Na⁺].

Method C (Reduction): Amine-9-benzyl ether (Structure 6)

A reduction reaction occurs to form the amine-9-benzyl ether wherein a sonicated solution of NiCl₂.6H₂O (144 mg, 610 μmol) in MeOH (30 mL) is prepared. NaBH₄ (69 mg, 1.82 mmol) is added portion-wise, resulting in the formation of a black suspension of NiB. The suspension is sonicated for an additional 30 minutes, then a solution containing Structure 5 (1.80 g, 1.09 mmol) in EtOH-toluene (10:1; 22 mL) is added. The mixture is stirred at 50° C., while adding NaBH₄ (460 mg, 12.12 mmol) portion-wise over three hours. After the final addition of NaBH₄, the stirred mixture is maintained at 50° C. for one hour. The suspension is filtered through a celite pad, which is washed with MeOH. The filtrate is collected and the solvent is removed in vacuo to leave a pale green solid, which is extracted with CH₂Cl₂. The combined extract is washed with 30% aqueous NH₄OH, followed by H₂O. The organic solution is dried (MgSO₄) and the solvent is removed in vacuo affording to material, which is column chromatographed (Al₂O₃) eluting with 10% MeOH in EtOAc to give Structure 6 (89%), as a colorless oil: 1.58 g; ¹H NMR δ 1.52 (s, 18H, CH₂CH₂CH₂O), 1.73 (s, 24H, CH₂CH₂CH₂O, CH₂CH₂CONH), 1.99 (s, 6H, CH₂CH₂CONH), 3.42 (t, 18H, CH₂CH₂CH₂O, J=6.0 Hz), 4.46 (s, 18H, OCH₂Ph), 5.74 (s, 3H, CONH), 7.31 (m, 45H, Ph); ¹³C NMR δ 23.6 (CH₂CH₂CH₂O), 31.4 (CH₂CH₂CONH), 31.4 (CH₂CH₂CH₂O), 35.1 (CH₂CH₂CONH), 52.6 (H₂NC), 58.1 (CONHC), 70.5 (CH₂CH₂CH₂O), 72.8 (OCH₂Ph), 127.4, 127.6, 128.2, 138.3 (Ph), 172.3 (CONH); IR (KBr) 3327, 3064, 3028, 2940, 2858, 2792, 1669, 1540, 1453, 1362, 1100 cm⁻¹; ESI-MS: m/z=1620.8 [M+H⁺]; Calcd. m/z=1620.2 [M+H⁺].

Method D (Isocvanate reagent formation): lsocvanate-9-benzyl ether (Structure 7)

To form the isocyanate reagent, a stirred solution of second generation amine (Structure 6) (900 mg, 550 μmol) and Et₃N (256 μL, 1.39 mmol) in CH₂Cl₂ (20 mL), triphosgene (110 mg, 278 μmol) is added over a period of 20 minutes at −5° C. After completion of the addition, the temperature is maintained for 1.5 hours and stirring is contained. The solvent is removed in vacuo to afford mixture, to which a solution of EtOAc and EtₜO (1:1 v/v) is added. The resulting mixture is stirred for five minutes and Et₃N-HCI is filtered. The mixture is washed with the same solvent mixture. The filtrate is washed with water and then dried using MgSO₄. After filtration, the solvent is removed in vacuo and the residue is chromatographed (SiO₂) eluting with 50% EtOAc in hexane to yield (90%) Structure 7, as an oil: 820 mg; ¹H NMR 6 1.54 (s, 18H, CH₂CH₂CH₂O), 1.74 (s, 24H, CH₂CH₂CH₂O, CH₂CH₂CONH), 2.02 (s, 6H, CH₂CH₂CONH), 3.44 (s, 18H, CH₂CH₂CH₂O), 4.47 (s, 18H, OCH₂Ph), 5.76 (s, 3H, CONH), 7.31 (m, 45H, Ph); ¹³C NMR δ 23.5 (CH₂CH₂CH₂O), 31.2 (CH₂CH₂CONH), 31.4 (CH₂CH₂CH₂O), 34.5 (CH₂CH₂CONH), 58.1 (CONHC), 61.9 (OCNC), 70.4 (CH₂CH₂CH₂O), 72.7 (OCH₂Ph), 122.1 (OCN), 127.3, 127.8, 128.1, 138.2 (Ph), 170.8 (CONH); IR 3334, 3062, 3030, 2947, 2857, 2792, 2257, 1660, 1539, 1454, 1360, 1101 cm⁻¹; ESI-MS: m/z=1646.2 [M⁺]; Calcd. m/z=1646.2 [M⁺].

Silane-9-benzyl ether (Structure 8)

Following Method A, the benzyl ether (Structure 7) (650 mg, 390 μmol) is placed in dry CH₂Cl₂ (20 mL) with 3-triethoxysilylpropylamine (95 μL, 0.39 mmol). After standard procedures, Structure 8 is formed and isolated (99%) as a colorless oil: 790 mg; ¹H NMR δ 0.59 (t, 2H, SiCH₂CH₂CH₂), 1.19 (m, 11H, CH₃CH₂O, SiCH₂CH₂CH₂), 1.47 (s, 18H, CH₂CH₂CH₂O), 1.67 (s, 18H, CH₂CH₂CH₂O), 1.92 (s, 6H, CH₂CH₂CONH), 2.09 (s, 6H, CH₂CH₂CONH), 3.07 (t, 2H, SiCH₂CH₂CH₂) 3.40 (s, 18H, CH₂CH₂CH₂O), 3.78 (q, 6H, CH₃CH₂O), 4.43 (s, 18H, OCH₂Ph), 6.13 (s, 3H, CONH), 7.29 (m, 45H, Ph); ¹³C NMR δ 7.3 (SiCH₂CH₂CH₂), 17.9 (CH₃CH₂O), 23.3 (CH₂CH₂CH₂O, SiCH₂CH₂CH₂), 30.7 (CH₂CH₂CH₂O), 31.4 (CH₂CH₂CONH), 32.7 (CH₂CH₂CONH), 42.3 (SiCH₂CH₂CH₂), 56.3 (NHCONHC), 57.7 (CONHC), 57.9 (CH₃CH₂O), 70.3 (CH₂CH₂CH₂O), 72.5 (OCH₂Ph), 127.1, 127.3, 127.9, 137.9 (Ph), 157.5 (NHCONH), 172.5 (CONH); IR 3327, 3062, 3029, 2940, 2859, 2793, 1652, 1541, 1101 cm⁻¹; ESI-MS: m/z=1867.6 [M⁺]; calcd. m/z=1867.5 [M⁺].

Nitro-27-benzyl ether (Structure 10)

Following Method B, a nonacid (Structure 9)(500 mg, 530 μmol) in dry DMF (5 mL) is placed with DCC (1.05 g, 5.11 mmol) and 1-HOBT (690 mg, 5.11 mmol) at 25° C. followed by the amine of Structure 1 (2.43 g, 5.11 mmol). The resulting product is Structure 10, which is a colorless oil: 2.51 g; ¹H NMR δ 1.52 (s, 54H, CH₂CH₂CH₂O), 1.73 (s, 54H, CH₂CH₂CH₂O), 2.05 (m, 48H, CH₂CH₂CONH), 3.54 (s, 54H, CH₂CH₂CH₂O), 4.48 (s, 54H, OCH₂Ph), 6.13 (s, 12H, CONH), 7.30 (m, 135H, Ph); ¹³ C NMR δ 23.5 (CH₂CH₂CH₂O), 30.9 (CH₂CH₂CONH), 30.9 (CH₂CH₂CH₂O), 57.8 (1^{st}—CONHC), 58.1 (2^{nd}—CONHC), 70.5 (CH₂CH₂CH₂O), 72.7 (OCH₂Ph), 93.3 (O₂NC), 127.3, 127.5, 128.1, 138.2 (Ph), 172.2 (CONH); IR: 3324, 3063, 3029, 2942, 2854, 1661, 1540, 1454, 1362, 1101 cm⁻¹; MALDI-TOF m/z=5106.6 [M+H⁺]; Calcd. m/z=5106.8 [M+H⁺].

Amine-27-benzyl ether (Structure 11)

Following Method C, Structure 10 (1.2 g, 23.6 μmol) is reduced (71%) to the desired amine (i.e., Structure 11) as a colorless oil: 850 mg; ¹H NMR δ 1.52 (s, 54H, CH₂CH₂CH₂O), 1.72 (s, 54H, CH₂CH₂CH₂O), 2.01 (m, 48H, CH₂CH₂CONH), 3.44 (s, 54H, CH₂CH₂CH₂O), 4.48 (s, 54H, OCH₂Ph), 6.12 (s, 12H, CONH), 7.34 (m, 135H, Ph); ¹³C NMR δ 23.3 (CH₂CH₂CH₂O), 30.8 (CH₂CH₂CONH), 30.8 (CH₂CH₂CH₂O), 49.3 (H₂NC), 57.5 (1^{st}—CONHC), 57.8 (2^{nd}—CONHC), 70.3 (CH₂CH₂CH₂O), 72.5 (OCH₂Ph); 127.1, 127.3, 127.9, 137.9 (Ph), 171.9 (CONH); IR: 3323, 3062, 3030, 2945, 2857, 1651, 1539, 1454, 1361, 1101 cm⁻¹; MALDI-TOF: m/z=5054.0 [M⁺]; Calcd. m/z=5053.8 [M⁺].

Isocyanate-27-benzyl ether (Structure 12)

Following Method D, the second generation amine of Structure 11 (600 mg, 11.9 μmol) is reacted with triphosgene (36, 11.9 μmol) to transform (63%) to the desired isocyanate, Structure 12: 370 mg; ¹H NMR δ 1.49 (s, 54H, CH₂CH₂CH₂O), 1.69 (s, 54H, CH₂CH₂CH₂O), 2.01 (m, 48H, CH₂CH₂CONH), 3.41 (s, 54H, CH₂CH₂CH₂O), 4.44 (s, 54H, OCH₂Ph), 6.08 (s, 12H, CONH), 7.29 (m, 135H, Ph); ¹³C NMR δ 23.4 (CH₂CH₂CH₂O), 30.9 (CH₂CH₂CONH), 30.9 (CH₂CH₂CH₂O), 57.5 (1^{st}—CONHC), 57.8 (2^{nd}—CONHC), 60.3 (OCNC), 70.4 (CH₂CH₂CH₂O), 72.6 (OCH₂Ph), 127.2, 127.3, 127.9, 138.1 (Ph), 172.0 (CONH); IR 3326, 3063, 3030, 2946, 2859, 2248, 1654, 1538, 1455, 1362, 1101 cm⁻¹; MALDI-TOF m/z=5080.2 [M+H⁺]; Calcd. m/z=5080.8 [M+H⁺].

Silane-27-benzyl ether (Structure 13)

After Method A, the isocyanate of Structure 12 (500 mg, 0.98 μmol) is reacted with 3-triethoxysilylpropylamine (24 μL, 0.98 μmol) to produce (99%) of silane-27-benzyl ether (i.e., Structure 13) as a colorless oil: 519 mg; ¹H NMR δ 0.59 (s, 2H, SiCH₂CH₂CH₂), 1.20 (m, 11H, CH₃CH₂O, SiCH₂CH₂CH₂), 1.47 (s, 54H, CH₂CH₂CH₂O), 1.68 (s, 54H, CH₂CH₂CH₂O), 1.92 (s, 24H, CH₂CH₂CONH), 2.09 (s, 24H, CH₂CH₂CONH), 3.10 (s, 2H, SiCH₂CH₂CH₂), 3.42 (s, 54H, CH₂CH₂CH₂O), 3.78 (q, 6H, CH₃CH₂O), 4.43 (s, 18H, OCH₂Ph), 5.30 (2H, NHCONH), 6.04 (s, 12H, CONH), 7.29 (m, 135H, Ph); ¹³C NMR δ 7.3 (SiCH₂CH₂CH₂), 17.9 (CH₃CH₂O), 23.3 (CH₂CH₂CH₂O, SiCH₂CH₂CH₂), 30.7 (CH₂CH₂CH₂O), 31.4 (CH₂CH₂CONH), 32.7 (CH₂CH₂CONH), 42.3 (SiCH₂CH₂CH₂), 56.3 (NHCONHC), 57.7 (CONHC), 57.9 (CH₃CH₂O), 70.3 (CH₂CH₂CH₂O), 72.5 (OCH₂Ph), 127.1, 127.3, 127.9, 137.9 (Ph), 157.5 (NHCONH), 172.5 (CONH); IR 3327, 3062, 3029, 2940, 2859, 2793, 1652, 1541, 1101 cm⁻¹; ESI-MS: m/z=5301.2 [M⁺]; Calcd. m/z=5301.2 [M⁺].

Preparation of the Sol-gel Dendritic Solution

Three separate sol-gel solutions are prepared using three different dendritic reagents, each containing a triethoxysilane group at the root. In order to accomplish this, 100 mg of the selected dendritic reagent (Structure 2, Structure 7, or Structure 12) is dissolved in CH₂Cl₂ (100 μL) and placed in a microcentrifuge tube (1.5 mL). PMHS (40 μL) and MTMS (100 μL) are added and the contents of the centrifuge tube are thoroughly vortexed. Finally, TFA (100 μL), containing 5% water (sol-gel catalyst and source of water) is added to the centrifuge tube and vortexed again. The contents of the tube are then centrifuged four minutes at 13,000 rpm (15,682 G) to separate any precipitate that may have formed during the mixing process. The clear sol-gel solution from the top of the centrifuge tube is then transferred to a clean vial for further use.

Preparation of the Capillary GC Column

The sol-gel dendritic solution is used to prepare open tubular GC column following a general procedure described in an earlier publication (D. Wang et al.) A hydrothermally treated fused silica capillary (10 m×250 μM i.d.) is filled with the sol-gel dendritic solution using a homemade filling/purging device (J. D. Hayes et al.) under 100 psi helium pressure. The solution remains inside the capillary for 15 minutes; afterwards, it is expelled from the capillary under helium pressure. Next, the capillary is dried by purging it with helium for 30 minutes at 25° C. Then, the capillary is conditioned thermally under a continuous flow of helium: from 40 to 280° C. at 1° C. minutes⁻¹, holding the column at the final temperature for five hours. Finally, the column is rinsed with CH₂Cl₂ and dried under a helium purge. At this point, the column is ready for analytical use.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

### References

Abe, I.; Kameyama, K.; Wasa, T.; Chromatographia 27, 631-633 (1989).
Altgelt, K. H.; Gouw, T. H., Chromatography in Petroleum Analysis, Marcel Dekker, New York, 1979.
K. Aoi, “Sugar balls”, Kobunshi 1996, 45, 260.
K. Aoi, K. Itoh, M. Okada, “Globular Carbohydrate Macromolecule “Sugar Balls”. 1. Synthesis of Novel Sugar-Persubstituted Poly(amido amine) Dendrimers”, Macromolecules 1995, 28, 5391-5393.
K. Aoi, K. Tsutsumiuchi, A. Yamamoto, M. Okabe, “Globular Carbohydrate Macromolecules “Sugar Balls” 3. “Radial-Growth Polymerization” of Sugar-Substituted α-Amino N-Carboxyanhydrides (GlycoNCAs) with a Dendritic Initiator”, Tetrahedron 1997, 53, 15415-15427.
K. Aoi, K. Tsutsumiuchi, A. Yamamoto, M. Okada, “Globular carbohydrate macromolecules “Sugar Balls”, 2 Synthesis of mono(glycopeptide)-persubstituted dendrimers by polymer reaction with sugar-substituted α-amino acid N-carboxyanhydrides (glycoNCAs)”, Macromol, Rapid Commun. 1998, 19, 5-9.
D. Astruc, J.-C. Blais, e. Cloutet, L. Djakovitch, S. Rigaut, J Ruiz, V. Sartor, C. Valério, “The First Organometallic Dendrimers: Design and Redox Functions”, Top. Curr. Chem. 2000, 210, 229-259.
Bartle, K. D.; Woolley, C. L.; Markides, K. E.; Lee, M. L.; Hansen, R. S. J. High Resolut Chromatogr./Chromatogr. Commun 1987, 10, 128-136.
S. B. Bendre, A. N. Kadam, B. B. Ghatge, “Comparative gas chromatographic studies of bonded and physically coated PEG 20M and its derivative phases with reference to some high-boiling isomeric solutes”, J. Chromatogr. 1985, 346, 359-362.
Berezkin, V. G., Drugov, I. S., Gas Chromatography in Air Pollution Analysis, Elsevier, Amsterdam, 1991.
S. Bhattacharya, P. V. Dileep, “Synthesis of novel cationic lipids with oxyethylene spacers at the linkages between hydrocarbon chains and pseudoglyceryl backbone”, Tetrahedron Lett. 1999, 40, 8167-8171.
P. Bhyrappa, J. K. Young, J. S. Moore, “Dendrimer-Metalloporphyrins: Synthesis and Catalysis”, J. Am. Chem. Soc. 1996. 118, 5708-5711.
Blomberg, L.; Markides, K. E.; Wannman, T. J. High Resolut. Chromatogr. Chromatogr. Commun. 1980, 3, 527.
L. G. Blomberg, J. Microcol. September 1990, 2, 62-67.
Blomberg, L.; Wannman, T. J. Chromatogr. 1978, 148, 379-387.
J. Bouche, M. Verzele, “A Static Coating Procedure for Glass Capillary Columns”, J. Gas Chromatogr. 1968, 6, 501-505.
J. S. Bradshaw, c. Schregenberger, K.-H. C. Chang, K. E. Markides, M. L. Lee, “Synthesis and Chromatographic Properties of Polysiloxane Stationary Phases Containing Biphenylcarboxylate Ester Liquid—Crystalline Side Groups”, J. Chromatogr. 1986, 358, 95-106.
Brinker, C. J., Scherer, G. W., Sol-gel Science, Academic Press, San Diego, 1990.
C. M. Cadado, I. Cuadrado, M. Morán, B. Alonso, B. Garcia, B. González, J. Losada, “Redox-active ferrocenyl dendrimers and polymers in solution and immobilized on electrode surfaces”, Coord. Chem. Rev. 1999, 185-186, 53-79.
S. L. Chong, D. Wang, J. D. Hayes, B. W. Wilhite, A. Malik, “Sol-Gel Coating Technology for the Preparation of Solid-Phase Microextraction Fibers for Enhanced Thermal Stability”, Anal. Chem. 1997, 69, 3889-3898.
Clement, R. E. (ed.), Gas chromatography: Biochemical, Biomedical, and Clinical Applications, Wiley, New York, 1990.
I, Cuadrado, M. Morán, C. M. Casado, B. Alonso, J. Losada, “Organometallic dendrimers with transition metals”, Coord. Chem. Rev. 1999, 193-195, 395-445.
I. Cuadrado, M. Morán, J. Losada, C. M. Casado, C. Pascual, B. Alonso, F. Lobete, “Organometallic dendritic macromolecules: organosilicon and organometallic entities as cores or building blocks” in Advances in Dendritic Macromolecules, (Ed.: G. R. Newkome), JAI, Greenwich, Conn. 1996, pp. 151-195.
Ettre, L. S., Hinshaw, J. V. Basic Relationship in Gas Chromatography, Advanstar, Cleveland, USA, 1994, p. 144.
D. D. Fine, H. L. Gearhaid, II, H. A. Mottola, “Preparation and Gas-chromatographic Characterization of Some Crown-Ether Stationary Phases”, Talanta 1985, 32, 751-756.
H. Frank, G. J. Nicholson, E. Bayer, “Rapid Gas Chromatographic Separation of Amino acid Enantiomers with a Novel Chiral Stationary Phase,” J. Chromatogr. Sci. 1977, 15, 174-176.
Golay, M. J. E., in Coates, V. J.; Noebels, H. J.; Faberson I. S. (eds.), Gas Chromatography (1957 Lansing Symposium), Academic Press, New York, 1958, pp. 1-013.
C. Gorman, “Metallodendrimers: Structural Diversity and Functional Behavior”, Adv. Mater. (Weinheim, Fe. Repub. Ger.) 1998, 10, 295-309.
K. Grob, Jr., G. Grob, K. Grob, “Comprehensive, Standardized Quality test for Gas Capillary Columns”, J. Chromatogr. 1978, 156,1-20.
J. D. Hayes, A. Malik, “Sol-gel chemistry-based Ucon-coated columns for capillary electrophoresis”, J. Chromatogr. B 1997, 695, 3-13.
J. D. Hayes, A. Malik, “Sol-Gel Monolithic Columns with Reversed Electroosmotic Flow for Capillary Electrochromatography”, Anal. Chem. 2000, 72, 4090-4099.
J. D. Hayes, A. Malik, “Sol-Gel Open Tubular ODS Columns with Reversed Electroosmotic Flow for Capillary Electrochromatography”, Anal. Chem. 2001, 73, 987-996.
A. Hierlemann, J. K. Campbell, L. A. Baker, R. M. Crooks, A. J. Ricco, “Structural Distortion of Dendrimers on Gold Surfaces: A Tapping-Mode AFM Investigation”, J. Am. Chem. Soc. 1998, 120, 5323-5324.
A. T. James, A. J. P. Martin, “Gas-liquid Partition Chromatography: the Separation and Micro-estimation of Volatile Fatty Acids from Formic Acid to Dodecanoic Acid”, Biochem, J. 1952, 50, 679-690.
N. Jayaraman, S. A. Nepogodiev, J. F. Stoddart, “Synthesis and study of dendritic polysaccharides”, Carbohydrates in Europe 1998, 30-33.
E. Koivusalmi, E. Haatainen, A. Root, “Quantitative RP-HPLC Determination of Some Alhehydes and Hydroxyaldehydes as Their 2,4-Dinitrophenylhydrazone Derivatives”, Anal. Chem. 1999, 71, 86-91.
C. Kollner, B. Pugin, A. Togni, “Dendrimers Containing Chiral Ferrocenyl Diphospine Ligands for Asymmetric Catalysis”, J. Am. Chem. Soc. 1998, 120,10274-10275.
C. Köllner, R. Schneider, A. Togni, “Characterization of catalytically Active Ferrocenyl Dendrimers”, Chimia 1999, 53, No. 107.
Koppenhoefer, B.; Muhleck, U.; Lohmiller, “Backbone Modification of Chirasil-Val I. Effect of Loading on the Separation of Enantiomers by Gas Chromatography,” J. Chromatogr. A. 1995, 699, 215-221.
X. H. Lai, L. Lin, C. Y. Wu, “Preparation and Chromatographic Characteristics of Clix[4]arene Polysiloxane as Stationary Phases for Capillary Gas Chromatography”, Chromatographia 1999, 50, 82-83.
Lawrocki, J. Chromatographia1991, 31,177-205.
Lee, M. L.; Kong, R. C.; Woolley, C. L.; Bradshaw, J. S. J. Chromatogr. Sci. 1984, 22, 136-142.
M. L. Lee, J. C. Kuei, N. W. Adams, B. J. Tarbet, M. Nishioka, B. A. Jones, J. S. Bradshaw, “Polarizable polysiloxane stationary phases for capillary column gas chromatography”, J. Chromatogr. 1984, 302, 303-318.
A. Malik, I. Ostrovsky, S. R. Sumpter, S. L. Reese, S. Morgan, B. E. Rossiter, J. S. Bradshaw, M. L. Lee, “Novel Cyanobiphenylpolysiloxane Stationary Phases for Gas and Supercritical Fluid Chromatography”, J. Microcol. September 1992, 4, 529-540.
A. Malik, S. L. Reese, s. Morgan, J. S. Bradshaw, M. L. Lee, “Dicyanobiphenyl Polysiloxane Stationary Phases for Capillary Column Gas Chromatography”, Chromatographia 1997, 46, 79-84.
K. E. Markides, L. Blomberg, J. Buuten, T. Wännman, “Cyanosilicones as stationary phases in gas chromatography, I.”, J. Chromatogr. 1983, 254, 53-61.
Mayer, B. X. et al., J. Chromatogr. A., 917, 219-226
V. V. Narayanan, G. R. Newkome, “Supramolecular Chemistry within Dendritic Structures”, Top. Curr. Chem. 1998, 197, 19-77.
G. R. Newkome, C. D. Weis, “Method of utilizing isocyanate linkage for forming multi-tier cascade polymers”, U.S. Pat. No. 5,703,271 (1997).
G. R. Newkome, C. D. Weis, “Method of Utilizing Isocyanate Linkages for Forming Multi-tier Cascade Polymers”, U.S. Pat. No. 5,773,551 (1998).
G. R. Newkome, C. D. Weis, B. J. Childs, “Synthesis of 1→3 Branched Isocyanate Monomers for Dendritic Construction”, Designed Monomers and Polymers 1997A, 1, 3-14.
G. R. Newkome, C. D. Weis, C. N. Moorefield, F. R. Fronczek, “A useful dendritic building block: di-tert-butul 4-[2-tert-butoxycarbonyl)ethyl]-4-isocyanato-1,7-heptanedicarboxylate”, Tetrahedron Lett. 1997, 38, 7053-7056.
G. R. Newkome, C. N. Moorefield, “Combinatorial method of forming cascade polymer surfaces”, U.S. Pat. No. 5,886,126 (1999).
G. R. Newkome, C. N. Moorefield, “Combinatorial method of forming cascade polymer surfaces”, U.S. Pat. No. 5,886,127 (1999).
G. R. Newkome, C. N. Moorefield, “Dendrimers” in Comprehensive Supramolecular Chemistry, (Ed.: D. N. Reinhoudt), Pergamon, New York 1996, pp. 777-832.
G. R. Newkome, C. N. Moorefield, G. R. Baker, “Building blocks for dendritic macromolecules”, Aldrichim. Acta 1992, 25, 31-38.
G. R. Newkome, E. He, C. N. Moorefield, “Suprasupermolecules with Novel Properties: Metallodendrimers”, Chem. Rev. 1999, 99, 1689-1746.
G. R. Newkome, R. K. Behera, C. N. Moorefield, G. R. Baker, “Cascade Polymers: Synthesis and Characterization of One-Directional Arborols Based on Adamantane”, J. Org. Chem. 1991, 56, 7162-7167.
de Nijs, R. C. M.; Franken, J. J.; Dooper, R. P. M.; Rijks, J. A.; de Ruwe, H. J. J. M.; Schulting, F. L. J. Chromatogr. 1978, 167, 231-242.
J. H. Park, H. J. Lim, Y. K. Lee, J. K. Park, B. E. Kim, J. J. Ryoo, K.-P. Lee, “Separation of Positional Isomers on A,C,-and A,D-Bridged Calix[6]arene as Stationary Phases in Capillary GC”, J. High Resolut. Chromatogr. 1999, 22, 679-682.
C. F. Poole, H. T. Butler, M. E. Coddens, S. C. Dhanesar, F. Pacholec, J. Chromatogr. 1984, 289, 299-320.
Poole, C. F.; Poole S. K., in E. Heftman (ed.) Chromatography, 5th Edition, Part A: Fundamentals and Techniques (J. Chromatogr. Libr. Vol. 51A, Amsterdam, 1992), ch. 9.
M. T. Reetz, “New Supramolecular Transition Metal Catalysts”, J. Heterocycl. Chem. 1998, 35, 1065-1073.
R. Roy, S. K. Das, “Recent applications of olefin metathesis and related reactions in carbohydrate chemistry”, Chem. Commun. 2000, 519-529.
P. Sandra, M. van Roelenbosch, “Mixed Phases of Superox and OV-1 in Fused-Silica and Glass-Capillary Gas-Chromatography”, Chromatographia 1981, 14, 345-350.
Schomburg, G.; Husmann, H.; Borwitsky, H., Chromatographia 1979, 12, 651-660.
S. Serroni, S. Campagna, G. Denti, A. Juris, M. Venturi, V. Balzani,
“Dendrimers based on metal complexes” in Advances in Dendritic Macromolecules, Advances in Dendritic Macromolecules, (Ed.: G. R. Newkome), JAI, Greenwich, Conn. 1996, pp. 61-113.
T. Shinbo, Y. Shimabukuro, T. Kanamori, T. lwatsubo, Y. Nagawa, K. Hiratani, “Separation of aromatic isomers on cyclophane-bonded stationary phases”, J. Chromatogr. A. 2000, 877, 61-69.
D. K. Smith, F. Diederich, “Supramolecular Dendrimer Chemistry—A Journey Through the Branched Architecture”, Top. Curr. Chem. 2000, 183-227.
Sumpter, S. R.; Woolley, C. L.; Huang, E. C.; Markides, K. E.; Lee, M. L. J. Chromatogr. 1990, 517, 503-519.
B. J. Tarbet, J. S. Bradshaw, K. E. Markides, M. L. Lee, B. A. Jones, “The chemistry of capillary column technology”, LC-GC 1988, 6, 237-248.
Tebbett, I. (Ed.), Gas Chromatography in Forensic Science, E. Horwood, New York, 1991.
C. R. Trash, “Methylsilicones—Their Chemistry and Use as Gas—Chromatographic Liquid—Phases”, J. Chromatogr. Sci. 1973, 11, 196-198.
M. Venturi, S. Serroni, A. Juris, S. Campagna, V. Balzani, “Electrochemical and Photochemical Properties of Metal-Containing Dendrimers”, Top. Curr. Chem. 1998, 197, 193-228.
D. Wang, S. L. Chong, A. Malik, “Sol-Gel Column Technology for Singe-Step Deactivation, Coating, and Stationary-Phase Immobilization in High-Resolution Capillary Gas Chromatography”, Anal. Chem. 1997, 69, 4566-4576.
Woolley, C. L.; Kong, R. C.; Richter, B. E.; Leo, M. L., J. High Resolut. Chromatogr. Chromatogr. Commun. 1984, 7, 329-332.
C. L. Woolley, K. E. Markides, M. L. Lee, “Deactivation of fused-silica capillary columns with polymethylhydrosiloxanes. Optimization of reaction conditions”, J. Chromatogr. 1986, 367, 9-22.
Wright, B. W.; Peaden, P. A.; Lee M. L.; and Stark T. J., J. Chromatogr. 1982, 248, 17-34.
Yakabe, Y.; Sudoh, Y.; Takahata, Y. J. Chromatogr. 1991, 558, 323-327.
G. Yi, J. S. Bradshaw, B. E. Rossiter, A. Malik, W. Li, M. L. Lee, “New Permethyl-Substituted β-Cyclodextrin Polysiloxanes for Use as Chiral Stationary Phases in Open Tubular Column Chromatography”, J. Org. Chem. 1993, 58, 4844-4850.
F. Zeng, S. C. Zimmerman, “Dendrimers in Supramolecular Chemistry: From Molecular Rrecognition to Self-Assembly”, Chem. Rev. 1997, 97, 1681-1712.

F. J. Stoddart, T. Welton, “Metal-containing dendritic polymers”, Polyhedron 1999, 18, 3575-3591.

TABLE 1
Run to run & capillary to capillary peak area repeatability, retention time repeatability, and
detection limit data for ppb and sub-ppb level concentrations of PAH's, aldehydes, and
ketones in five replicate measurements by OTME-GC using sol-gel dendrimer coatings

| Peak area repeatability (n = 5) | | Retention | |
|---|---|---|---|
| Capillary to | | time (t_{R}) | |
| capillary | Run to run | repeatability | |
| Mean | Mean peak | (n = 10) | Detection |

| | | peak area | | area | | Mean | | Limits |
|---|---|---|---|---|---|---|---|---|
| Chemical Class | Name of the | (arbitrary | RSD | (arbitrary | RSD | t_{R} | | S/N = 3 |
| of the Analyte | Analyte | unit) | (%) | unit) | (%) | (min) | RSD % | (ppt) |
| Polyaromatic | Acenaphthene | 20001 | 2.08 | 32748 | 5.27 | 14.90 | 0.05 | 3.6 |
| Hydrocarbons | Fluorene | 42705 | 2.58 | 50171 | 4.27 | 15.77 | 0.03 | 2.3 |
| | Phenanthrene | 48103 | 2.04 | 58985 | 2.33 | 17.41 | 0.02 | 2.1 |
| | Fluoranthene | 65389 | 3.46 | 63814 | 1.46 | 19.42 | 0.04 | 2.2 |
| | Pyrene | 82694 | 5.72 | 64783 | 2.56 | 19.80 | 0.02 | 2.3 |
| Aldehydes | Nonyl aldehyde | 32479 | 9.20 | 32389 | 7.36 | 10.87 | 0.05 | 19.4 |
| | m-Tolualdehyde | 96287 | 6.79 | 95077 | 2.90 | 12.00 | 0.03 | 5.6 |
| | n-Decyl aldehyde | 174085 | 8.97 | 170101 | 4.09 | 13.02 | 0.04 | 3.3 |
| | Undecylic | 197249 | 7.60 | 213576 | 6.19 | 13.97 | 0.03 | 3.5 |
| | aldehyde | | | | | | | |
| Ketones | Butyrophenone | 31512 | 3.70 | 36832 | 1.37 | 12.58 | 0.04 | 44.3 |
| | Valerophenone | 60909 | 3.12 | 63127 | 2.52 | 13.58 | 0.04 | 11.7 |
| | Hexanophenone | 97759 | 3.81 | 80996 | 2.33 | 14.53 | 0.05 | 3.7 |
| | Heptanophenone | 92476 | 6.45 | 96529 | 2.31 | 15.41 | 0.06 | 1.9 |
| | Benzophenone | 68130 | 2.08 | 63168 | 3.39 | 16.12 | 0.04 | 15.2 |

TABLE 2
Run to run & capillary to capillary peak area repeatability, retention time repeatability, and
detection limit data for ppb and sub-ppb level concentrations of phenols, alcohols, and
preservatives in five replicate measurements by OTME-GC using sol-gel dendrimer coatings

| | | Peak area repeatability (n = 5) | | | | | | |
|---|---|---|---|---|---|---|---|---|
| | | Capillary to | | | | Retaintion | | |
| | | capillary | | Run to run | | time (t_{R}) | | |
| | | Mean | | Mean peak | | repeatability | | Detection |
| | | peak area | | area | | (n = 10) | | Limits |
| Chemical Class | Analyte's | (arbitrary | RSD | (arbitrary | RSD | Mean | | S/N = 3 |
| of the Analyte | name | unit) | (%) | unit) | (%) | tR (min) | RSD % | (ppt) |
| Phenols | 2-chlorophenol | 12870 | 7.59 | 16145 | 5.29 | 12.23 | 0.07 | 840 |
| | 2,5-dimethylphenol | 27643 | 5.58 | 28686 | 1.26 | 13.95 | 0.08 | 320 |
| | 3,4-dichlorophenol | 18879 | 2.53 | 19409 | 5.06 | 14.65 | 0.10 | 160 |
| | 2,4,6-trichlorophenol | 145939 | 3.87 | 155662 | 2.15 | 15.34 | 0.14 | 220 |
| | 4-chloro,3- | 64775 | 7.37 | 63808 | 0.49 | 16.03 | 0.14 | 260 |
| | methylphenol | | | | | | | |
| Alcohols | 1-Octanol | 217163 | 5.58 | 184083 | 6.60 | 12.55 | 0.08 | 20.0 |
| | Decanol | 282727 | 2.50 | 263930 | 6.14 | 14.27 | 0.07 | 3.0 |
| | Larayl alcohol | 165745 | 4.27 | 215507 | 2.50 | 15.82 | 0.08 | 2.0 |
| | Myristyl alcohol | 474889 | 6.18 | 414955 | 3.20 | 17.25 | 0.11 | 3.0 |
| Preservatives | 2,6-di-tert-butyl-p- | 78630 | 5.20 | 65343 | 6.63 | 14.89 | 0.14 | 3.0 |
| | cresol (BHT) | | | | | | | |

1. A capillary column comprising:
a tube structure including an inner surface; and
a sol-gel substrate bonded to a dendrimer substrate to form a sol-gel dendrimer matrix, wherein said sol-gel dendrimer matrix bonds to a portion of said inner surface of said tube structure to form a surface-bonded stationary phase coating thereon.

2. The capillary column according to claim 1, wherein said sol-gel substrate is made from sol-gel precursors having the general structure: 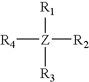
wherein,
Z=a precursor-forming element selected from the group consisting of silicon, aluminum, titanium, zirconium, vanadium, and germanium; and
R₁, R₂, R₃, and R₄=R-groups are moieties selected from the group consisting of sol-gel-active moieties, alkoxy moieties, hydroxy moieties, non-sol-gel-active methyl, octadecyl, and phenyl.

3. The capillary column according to claim 2, wherein said alkoxy groups are selected from the group consisting of a methoxy group, ethoxy group, n-Propoxy group, iso-Propoxy group, n-butoxy group, iso-butoxy group, and tert-butoxy group.

4. The capillary column according to claim 2, wherein one to two said R-groups are moieties selected from the group consisting of alkyl moieties and their derivatives, alkenyl moieties and their derivative, aryl moieties and their derivatives, arylene moieties and their derivatives, cyanoalkyl moieties and their derivatives, fluoroalkyl moieties and their derivatives, phenyl moieties and their derivatives, cyanophenyl moieties and their derivatives, byphenyl moiety and its derivatives, cyanobiphenyl moieties and their derivatives, dicyanobiphenyl moieties and their derivatives, cyclodextrin moieties and their derivatives, crown ether moieties and their derivatives, cryptand moieties and their derivatives, calixarene moieties and their derivatives, liquid crystal moieties and their derivatives, dendrimer moieties and their derivatives, cyclophane moieties and their derivatives, chiral moieties, and polymeric moieties.

5. The capillary column according to claim 4, wherein two to three said R-groups are moieties selected from the group consisting of methyl, octadecyl, phenyl, and hydrogen.

6. The capillary column according to claim 1, wherein said dendrimer substrate is made from monomers selected from the group consisting of isocyanates, isocyantates with benzyl ether terminal groups, t-butyl isocyanate monomers, and bis-homotris compounds, 4-amino-4-[1-(3-hydroxypropyl)]-1,7-heptanediol, 4-[1-(3-aminopropyl)]-4-[1-(3-hydroxypropyl)]-1,7-heptanediol, aminotriols, quaternary nitroalkanes, and other cascade monomers.

7. The capillary column according to claim 6, wherein said isocyanates are of the formula of O═C═N—C(CH₂—R)₃,
wherein R is selected from the group consisting of:
a) —CH₂-tbu;
b) —(CH₂)n-CH₂—COOR′;
c) —O—(CH₂)n-CH₂COOR′;
d) —O—(CH₂)n-CH₂—CN; and
e) —(CH₂)ₙ—CH₂—O—R″.
R′ being selected from the group consisting of alkyl (C-1 to C-20), cycloalkyl (C-3 to C-10), aryl, heteroaryl, polycycloalkyl, and adamantyl; and
R″ being selected from the group consisting of alkyl, cycloalkyl, aryl, —CO—R″′, —CS—R″′, —SO₂—R″′, —SiR″′₃, —(CH₂)ₙ—CH₂—CN, and —(CH₂)ₙ—CH₂—COOR″′;
wherein R″′ is alkyl (C-1 to C-20), cycloalkyl (C-3 to C-10), aryl, heteroaryl, polycycloalkyl, adamantyl, n=0-10 in all formulas.

8. The capillary column according to claim 1, wherein said sol-gel substrate further includes a residual of a deactivation reagent selected from the group consisting of polymethylhydrosiloxane, hexamethyldisilazane, 1,1,1,3,3,3-hexamethyldisilazane, hydrosiloxane, and hydrosilane.

9. The capillary column according to claim 1, wherein said sol-gel substrate further includes at least one baseline stabilizing reagent residual selected from the group consisting of residuals from bis(trimethoxysilylethyl)-benzene, sol-gel active reagents with phenyl-containing groups, and cyclohexane-containing groups.

10. The capillary column according to claim 1, wherein said tube structure is made of materials selected from the group consisting of glass, fused silica, alumina, titania, and zirconia.

11. A method of making a sol-gel and dendrimer solution for placement into a capillary column having inner walls by:
mixing suitable sol-gel precursor(s) and sol-gel active dendritic moieties to form a sol-gel solution;
hydrolyzing the sol-gel-active precursor(s) and dendritic moieties to form hydrolyzed products;
polycondensating the hydrolyzed products into a sol-gel dendrimer network; and
surface bonding the sol-gel dendrimer network on a portion of the capillary inner walls to form a surface bonded sol-gel dendrimer stationary phase coating thereon.

12. The method according to claim 11, wherein said mixing step further includes adding trifluoroacetic acid as the catalyst.

13. The method according to claim 12, wherein said mixing step further includes adding an additional catalyst selected from the group consisting of acids, bases or fluorides.

14. The method according to claim 11, wherein said hydrolyzing and polycondensating steps occur within the sol-gel solution placed inside the capillary column.

15. The method according to claim 11, wherein said deactivating step occurs at elevated temperatures during column conditioning.

16. The method according to claim 11, including the step of deactivating the sol-gel dendrimer stationary phase.

17. The method according to claim 11, including the step of hydrothermally pre-treating the capillary column.

18. A gas chromatography column comprising:
a capillary column including a tube structure having an inner surface; and
a sol-gel substrate bonded to a dendrimer moiety to form a sol-gel dendrimer matrix, wherein said sol-gel dendrimer matrix bonds to a portion of said inner surface of said tube structure to form a surface-bonded stationary phase coating thereon.

19. A capillary column comprising:
a tube structure including an inner surface;
a stationary phase coating attached to at least a portion of said inner surface; and
dendrimer moiety chemically bonded to said stationary phase coating for selectively interacting with various analytes.

20. The capillary column according to claim 19, wherein said stationary phase coating includes a sol-gel substrate made from sol-gel precursors having the general structure: 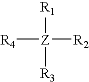
wherein,
Z=a precursor-forming element selected from the group consisting of silicon, aluminum, titanium, zirconium, vanadium, and germanium; and
R₁, R₂, R₃, and R4 =R-groups are moieties selected from the group consisting of sol-gel-active moieties, alkoxy moieties, hydroxy moieties, non-sol-gel-active methyl, octadecyl, and phenyl.

21. The capillary column according to claim 20, wherein said alkoxy groups are selected from the group consisting of a methoxy group, ethoxy group, n-Propoxy group, iso-Propoxy group, n-butoxy group, iso-butoxy group, and tert-butoxy group.

22. The capillary column according to claim 20, wherein said R-groups are at least two moieties selected from the group consisting of alkyl moieties and their derivatives, alkenyl moieties and their derivatives, aryl moieties and their derivatives, arylene moieties and their derivatives, cyanoalkyl moieties and their derivatives, fluoroalkyl moieties and their derivatives, phenyl moieties and their derivatives, cyanophenyl moieties and their derivatives, biphenyl moiety and its derivatives, cyanobiphenyl moieties and their derivatives, dicyanobiphenyl moieties and their derivatives, cyclodextrin moieties and their derivatives, crown ether moieties and their derivatives, cryptand moieties and their derivatives, calixarene moieties and their derivatives, liquid crystal moieties and their derivatives, dendrimer moieties and their derivatives, cyclophane moieties and their derivatives, chiral moieties, and polymeric moieties.

23. The capillary column according to claim 22, wherein remaining said R-groups are moieties selected from the group consisting of methyl, octadecyl, phenyl, and hydrogen.

24. The capillary column according to claim 19, wherein said dendrimer means is a substrate made from monomers selected from the group consisting of isocyanates, isocyantates with benzyl ether terminal groups, t-butyl isocyanate monomers, and bis-homotris compounds, 4-amino-4-[1-(3-hydroxypropyl)]-1,7-heptanediol, 4-[1-(3-aminopropyl)]-4-[1-(3-hydroxypropyl)]-1,7-heptanediol, aminotriols, quaternary nitroalkanes, and other cascade monomers.

25. The capillary column according to claim 24, wherein said isocyanates are of the formula of O═C═N—C(CH₂—R)₃,
wherein R is selected from the group consisting of:
a) —CH₂-tbu;
b) —(CH₂)n-CH₂-COOR′;
c) —O—(CH₂)n-CH₂COOR′;
d) —O—(CH₂)n-CH₂—CN; and
e) —(CH₂)ₙ—CH₂—O—R″.
R′ being selected from the group consisting of alkyl (C-1 to C-20), cycloalkyl (C-3 to C-10), aryl, heteroaryl, polycycloalkyl, and adamantyl; and
R″ being selected from the group consisting of alkyl, cycloalkyl, aryl, —CO—R″′, —CS—R″′, —SO₂—R″′, —SiR″′₃, —(CH₂)ₙ—CH₂—CN, and —(CH₂)ₙ—CH₂—COOR″′;
wherein R″′ is alkyl (C-1 to C-20), cycloalkyl (C-3 to C-10), aryl, heteroaryl, polycycloalkyl, adamantyl, n=0-10 in all formulas.

26. A method of preparing a capillary column by simultaneously deactivating, coating, and immobilizing a sol-gel dendrimer stationary phase on a tube structure.

27. The method according to claim 26 further defined as chemically bonding the sol-gel dendrimer stationary phase to an interfacial organic-inorganic polymer layer, the polymer layer evolving over a surface of the tube structure.

28. A separation and extraction apparatus comprising a stationary phase of a sol-gel bonded to a dendrimer moiety, said stationary phase bonded to a surface.

29. A separation and extraction phase comprising a sol-gel bounded to a dendrimer moiety.
